(19) United States
(12) Patent Application Publication
(10) Pub. No.: US 2025/0197784 A1
(43) Pub. Date: Jun. 19, 2025

(54) PIGMENT UNIT DOSE DETERGENT

(71) Applicant: Henkel AG & Co. KGaA, Duesseldorf (DE)

(72) Inventors: Jessica Eileen MCKEON, Bridgeport, CT (US); Mariusz HILDEBRANSKI, Shelton, CT (US); Daniel Joseph SKELLY, Milford, CT (US); Daniel Thomas PIORKOWSKI, Fairfield, CT (US)

(73) Assignee: Henkel AG & Co. KGaA, Duesseldorf (DE)

(21) Appl. No.: 18/896,143

(22) Filed: Sep. 25, 2024

Related U.S. Application Data
(60) Provisional application No. 63/611,897, filed on Dec. 19, 2023.

(51) Int. Cl. C11D 17/04; C11D 1/14; C11D 1/22; C11D 1/72; C11D 1/74; C11D 1/83; C11D 3/42

(52) U.S. Cl. CPC C11D 17/045; C11D 1/83; C11D 3/42; C11D 1/146; C11D 1/22; C11D 1/72; C11D 1/74

(57) ABSTRACT

The present disclosure provides a unit dose detergent comprising a water-soluble film material comprising a first compartment that is adjacent to a second compartment and separated by at least one layer of the film. The first compartment encloses a liquid composition comprising a non-aqueous solvent, and the second compartment encloses a powder composition comprising a pigment and at least one additive selected from a salt, a flow aid, acid, enzyme, chelating agent, a polymer, and any combination thereof; such that at least one of the liquid composition and the powder composition comprises a surfactant. Also provided is a method of preparing the powder composition for use in the unit dose detergent. The method includes adding the pigment to a salt to provide a pigment-salt combination and adding a flow aid to the pigment-salt combination to form the powder composition.

### BACKGROUND

Unit dose detergents formed from a water-soluble film and containing a liquid composition comprising water exhibit migration. Liquid detergent compositions typically include a combination of water and non-aqueous solvent. Water can move between materials and will migrate from high water active materials to low water active materials. Other solvents, including polyethylene glycol (PEG), can also move between materials and tend to disperse from concentrated regions to less concentrated regions. That is, PEG migrates from the liquid chamber where it is plentiful to the powder chamber where it is scarce until it reaches an equilibrium. A relatively inert and inexpensive base of powder formulations is salt, which has a very low water activity. Therefore, in a unit dose detergent containing both powder and water-containing liquid chambers, solvents tend to migrate from the liquid chamber to the powder chamber.

The aesthetics of a unit dose detergent can be improved by adding colorant to the powder composition. However, the migration of water from the liquid chamber to the powder chamber can disperse the colorant across the powder and create unsightly rings of uncoloured powder ringed in darker powder throughout the powder chamber.

Thus, there remains a need for a unit dose detergent with color stability despite solvent migration.

### BRIEF SUMMARY

The present disclosure relates to a unit dose detergent comprising
a water-soluble film material comprising at least a first compartment and a second compartment; wherein the first compartment is adjacent to the second compartment and the first and second compartments are separated by at least one layer of the film;
the first compartment enclosing a liquid composition comprising a non-aqueous solvent; and
the second compartment enclosing a powder composition comprising a pigment and at least one additive selected from a salt, a flow aid, acid, enzyme, chelating agent, a polymer, and any combination thereof;
wherein at least one of the liquid composition and the powder composition comprises a surfactant.

In some aspects, the pigment comprises at least one metal selected from the group consisting of aluminum, barium, cadmium, chromium, cobalt, copper, iron oxide, manganese, mercury, titanium, zinc, and any combination thereof.

In some aspects, the powder composition comprises about 0.001 wt % to about 3 wt % of pigment.

In some aspects, the powder composition does not contain a dye.

In some aspects, the non-aqueous solvent comprises an alcohol, a polyol, or a combination thereof. In some aspects, wherein the non-aqueous solvent comprises glycerin, propylene glycol, or a mixture thereof.

In some aspects, the liquid composition further comprises an additive selected from water, enzyme, performance polymer, rheology modifier, anti-redeposition polymer, chelating agent, fragrance, bitterant, and any combination thereof.

In some aspects, the liquid composition comprises water in an amount of 1 wt % to 20 wt % relative to the components in the liquid composition. In some aspects, the liquid composition comprises about 3 wt % to about 8 wt % water.

In some aspects, the liquid composition comprises at least one surfactant selected from a cocamide monethanolamine (MEA-cocoate), a cocoate, a monoethanolamine salt of a linear alkylbenzene sulfonate (MEA-LAS), an alkylether sulfate, a distyrylbiphenyl disulfonate, and any combination thereof.

In some aspects, the liquid composition has a pH of about 7.5 to about 11.

In some aspects, the powder composition comprises a salt selected from a chloride, a bromide, an iodide, a fluoride, a nitrate, a nitrite, a sulfate, a sulfite, a sulfide, a phosphate, a phosphide, a carbonate, a bicarbonate, and any combination thereof.

In some aspects, the powder composition comprises a flow aid selected from zeolite, calcium oxide, silica, a silicate, an aluminate, a citrate, a carbonate, a bicarbonate, a phosphate, a stearate, a clay, flour, fly ash, starch, and any combination thereof.

In some aspects, the powder composition comprises an alkylbenzene sulfonate.

In some aspects, the second compartment surrounds the first compartment.

In some aspects, the water-soluble film material comprises polyvinyl alcohol.

The present disclosure further relates to a method of preparing the powder composition of a unit dose detergent described herein comprising adding the pigment to a salt to provide a pigment-salt combination; followed by adding a flow aid to the pigment-salt combination to form the powder composition.

In some aspects of this method, the powder composition comprises about 0.001 wt % to about 3 wt % of pigment.

In some aspects of this method, the salt comprises a chloride, a bromide, an iodide, a fluoride, a nitrate, a nitrite, a sulfate, a sulfite, a sulfide, a phosphate, a phosphide, a carbonate, a bicarbonate, a citrate, or any combination thereof.

In some aspects of this method, the flow aid comprises silica, calcium oxide, a silicate, an aluminate, a citrate, a carbonate, a bicarbonate, a phosphate, a stearate, a clay, flour, fly ash, starch, zeolite, or any combination thereof.

### DETAILED DESCRIPTION

Provided herein is a unit dose detergent comprising a unit dose detergent comprising a water-soluble film material comprising at least a first compartment and a second compartment; wherein the first compartment is adjacent to the second compartment and the first and second compartments are separated by at least one layer of the film; the first compartment enclosing a liquid composition comprising a non-aqueous solvent; and the second compartment enclosing a powder composition comprising a pigment and at least one additive selected from a salt, a flow aid, acid, enzyme, chelating agent, a polymer, and any combination thereof; wherein at least one of the liquid composition and the powder composition comprises a surfactant.

Non-limiting examples of the various aspects are shown in the present disclosure.

### Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number+10%. For example, “about 10” means 9 to 11.

The phrase “substantially free of” means that a composition contains little to none of the specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one additive” means that 1, 2, 3, 4, or 5 or more additives are included in the composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant figures).

The term “by weight of the composition” as used in the present application refers to a composition of a final product derived from a process, unless otherwise defined.

The terms “process” and “method” as used in the present application can be used interchangeably.

The terms “preventing” or “prevents” as used in the present application refer to a pigment stain not forming when a textile is contacted with a unit dose detergent described herein. In some aspects, the preventing can be to any suitable degree, but typically a dry textile that has been in contact with a unit dose detergent described herein has a degree of staining that can be visually labeled as “clean” or “small amount of acceptable staining.” Unacceptable degrees of staining include those that can be visually labeled as “noticeable staining.”

### Unit Dose Detergent

The present disclosure is predicated on the discovery that solvent migration causing unsightly discoloration of colored powders in unit dose detergents can be minimized through the use of pigments. Pigments are typically less appropriate for in-wash laundry products than dyes because pigments are not water soluble and therefore pose increased staining risk compared to dyes. Pigments can also offset the color of fabrics, such as the yellowing of white fabrics. Moreover, pigments can contain high levels of heavy metals, which can react with other laundry additives or stain fabrics in the wash. Extensive testing demonstrated that at certain levels and with proper handling, inclusion of pigment prevents discoloration, in particular white spot formation, in colorful unit dose powders without staining fabric.

In some aspects, the present disclosure is directed to a unit dose detergent comprising a water-soluble film material comprising a first compartment and a second compartment; wherein the first compartment is adjacent to the second compartment and the first and second compartments are separated by at least one layer of the film; the first compartment enclosing a liquid composition comprising comprising a non-aqueous solvent; and the second compartment enclosing a powder composition comprising a pigment and at least one additive selected from a salt, a flow aid, acid, enzyme, chelating agent, a polymer, and any combination thereof; wherein at least one of the liquid composition and the powder composition comprises a surfactant. The unit dose detergent has a long, stable shelf life from an aesthetic perspective and does not deposit pigment on textiles when used in laundry care.

The first compartment encloses a liquid composition comprising a non-aqueous solvent. The non-aqueous solvent is any suitable solvent that has minimal impact on the migration of any water present that can be present in the first compartment. In some aspects, the non-aqueous solvent comprises an alcohol (e.g., a C₁₄ alcohol), a polyol, or any combination thereof. In some aspects, the polyol can be, for example, a diol (i.e., a glycol), a triol, a polyethylene glycol, a polypropylene glycol, or any combination thereof. In some aspects, the polyol is selected from ethylene glycol, diethylene glycol, triethylene glycol, diethylene glycol monobutyl ether, propylene glycol, dipropylene glycol, tripropylene glycol, dipropylene glycol monobutyl ether, 1,3-butylene glycol, 1,4-butylene glycol, 1-(1-butoxy-2-propoxy)-2-propanol, 2-methyl-2,4-pentanediol, 1,5-pentanediol, 1,6-hexanediol, glycerin, and any combination thereof. In some aspects, the polyol is propylene glycol, glycerin, or a combination of both.

In some aspects, the at least one non-aqueous solvent comprises polyethylene glycol (PEG), which can have the structure:

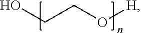

wherein n is an integer from 1 to 25 (e.g., 1 to 24, 1 to 23, 1 to 22, 1 to 21, 1 to 20, 1 to 18, 1 to 15, 1 to 12, 1 to 10, 2 to 25, 2 to 24 to 2 to 23, 2 to 22, 2 to 21, 2 to 20, 2 to 18, 2 to 15, 2 to 12, 2 to 10, 4 to 25, 4 to 23, 4 to 20, 4 to 18, 4 to 15, 4 to 12, 4 to 10, 7 to 25, 7 to 23, 7 to 20, 7 to 18, 7 to 15, 7 to 12, 7 to 10, 9 to 25, 9 to 23, 9 to 20, 9 to 18, 9 to 15, 9 to 12, etc.). In some aspects, n can be 1, 2, 3, 4, 5, 6, 7, 8, 9, 10, 11, 12, 13, 14, 15, 16, 17, 18, 19, 20, 21, 22, 23, 24, or 25.

In some aspects, the PEG has a molecular weight (including a number average molecular weight) of about 60 to about 1500 g/mol (e.g., about 60 to about 1200 g/mol, about 60 to about 1000 g/mol, about 100 to about 1500 g/mol, about 100 to about 1200 g/mol, about 100 to about 1000 g/mol, about 200 to about 1500 g/mol, about 200 to about 1200 g/mol, about 200 to about 1000 g/mol, about 300 to about 1500 g/mol, about 300 to about 1200 g/mol, about 300 to about 1000 g/mol, about 400 to about 1500 g/mol, about 400 to about 1200 g/mol, about 400 to about 1000 g/mol, about 200 g/mol, about 400 g/mol, about 600 g/mol, about 800 g/mol, or about 1000 g/mol). In some aspects, the non-aqueous solvent comprises polyethylene glycol with a molecular weight of about 200 to about 1000 g/mol or about 400 g/mol. In some aspects, the PEG comprises PEG 400, which has a number average molecular weight of about 380 to about 420 g/mol.

In some aspects, the liquid composition comprises from about 10 wt % to about 80 wt % of at least one non-aqueous solvent relative to the total weight of the liquid composition. For example, the total non-aqueous solvent content can be in an amount from about 10 wt % to about 75 wt %, about 10 wt % to about 70 wt %, about 10 wt % to about 65 wt %, about 10 wt % to about 60 wt %, about 10 wt % to about 55 wt %, about 10 wt % to about 50 wt %, about 10 wt % to about 45 wt %, about 10 wt % to about 40 wt %, about 10 wt % to about 35 wt %, about 10 wt % to about 30 wt %, about 10 wt % to about 25 wt %, about 10 wt % to about 20 wt %, about 10 wt % to about 15 wt %, about 15 wt % to about 80 wt %, about 15 wt % to about 75 wt %, about 15 wt % to about 70 wt %, about 15 wt % to about 65 wt %, about 15 wt % to about 60 wt %, about 15 wt % to about 55 wt %, about 15 wt % to about 50 wt %, about 15 wt % to about 45 wt %, about 15 wt % to about 40 wt %, about 15 wt % to about 35 wt %, about 15 wt % to about 30 wt %, about 15 wt % to about 25 wt %, about 15 wt % to about 20 wt %, about 20 wt % to about 80 wt %, about 20 wt % to about 75 wt %, about 20 wt % to about 70 wt %, about 20 wt % to about 65 wt %, about 20 wt % to about 60 wt %, about 20 wt % to about 55 wt %, about 20 wt % to about 50 wt %, about 20 wt % to about 45 wt %, about 20 wt % to about 40 wt %, about 20 wt % to about 35 wt %, about 20 wt % to about 30 wt %, about 20 wt % to about 25 wt %, about 25 wt % to about 80 wt %, about 25 wt % to about 75 wt %, about 25 wt % to about 70 wt %, about 25 wt % to about 65 wt %, about 25 wt % to about 60 wt %, about 25 wt % to about 55 wt %, about 25 wt % to about 50 wt %, about 25 wt % to about 45 wt %, about 25 wt % to about 40 wt %, about 25 wt % to about 35 wt %, about 25 wt % to about 30 wt %, about 30 wt % to about 80 wt %, about 30 wt % to about 75 wt %, about 30 wt % to about 70 wt %, about 30 wt % to about 65 wt %, about 30 wt % to about 60 wt %, about 30 wt % to about 55 wt %, about 30 wt % to about 50 wt %, about 30 wt % to about 45 wt %, about 30 wt % to about 40 wt %, about 30 wt % to about 35 wt %, about 35 wt % to about 80 wt %, about 35 wt % to about 75 wt %, about 35 wt % to about 70 wt %, about 35 wt % to about 65 wt %, about 35 wt % to about 60 wt %, about 35 wt % to about 55 wt %, about 35 wt % to about 50 wt %, about 35 wt % to about 45 wt %, about 35 wt % to about 40 wt %, about 40 wt % to about 80 wt %, about 40 wt % to about 75 wt %, about 40 wt % to about 70 wt %, about 40 wt % to about 65 wt %, about 40 wt % to about 60 wt %, about 40 wt % to about 55 wt %, about 40 wt % to about 50 wt %, about 40 wt % to about 45 wt %, about 45 wt % to about 80 wt %, about 45 wt % to about 75 wt %, about 45 wt % to about 70 wt %, about 45 wt % to about 65 wt %, about 45 wt % to about 60 wt %, about 45 wt % to about 55 wt %, about 45 wt % to about 50 wt %, about 50 wt % to about 80 wt %, about 50 wt % to about 75 wt %, about 50 wt % to about 70 wt %, about 50 wt % to about 65 wt %, about 50 wt % to about 60 wt %, about 50 wt % to about 55 wt %, about 55 wt % to about 80 wt %, about 55 wt % to about 75 wt %, about 55 wt % to about 70 wt %, about 55 wt % to about 65 wt %, about 55 wt % to about 60 wt %, about 60 wt % to about 80 wt %, about 60 wt % to about 75 wt %, about 60 wt % to about 70 wt %, about 60 wt % to about 65 wt, about 65 wt % to about 80 wt %, about 65 wt % to about 75 wt %, about 65 wt % to about 72 wt %, about 65 wt % to about 70 wt, about 70 wt % to about 80 wt %, about 70 wt % to about 75 wt %, about 70 wt % to about 72 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, or about 80 wt % of the total weight of the liquid composition.

In some aspects, the liquid composition comprises glycerin. In some aspects, the liquid composition comprises about 60 wt % to about 80 wt % glycerin.

In some aspects, the liquid composition comprises propylene glycol. In some aspects, the liquid composition comprises about 60 wt % to about 80 wt % propylene glycol.

In some aspects, the liquid composition comprises glycerin and propylene glycol. In some aspects, the liquid composition comprises about 5 wt % to about 15 wt % glycerin and about 5 wt % to about 15 wt % propylene glycol. The glycerin and propylene glycol (PG) can be used in any suitable ratio in the liquid composition. In some aspects, the weight ratio of Glycerin:PG will be about 1:1±10%.

In some aspects, the liquid composition comprises polyethylene glycol, glycerin, and propylene glycol. In some aspects, the liquid composition comprises about 10 wt % to about 40 wt % polyethylene glycol, about 20 wt % to about 30 wt % glycerin, and about 6 wt % to about 18 wt % propylene glycol. The polyethylene glycol (PEG), glycerin, and propylene glycol (PG) can be used in any suitable ratio in the liquid composition. In some aspects, the weight ratio of PEG:Glycerin:PG will be about 3:2:1±10%.

In some aspects, the liquid composition comprises at least one (e.g., 1, 2, 3, 4, 5, or 6, etc.) additive. In general, the additive is any suitable component that minimizes or does not increase solvent migration or discoloration of the powder composition. In some aspects, the additive can be a surfactant, water, enzyme, performance polymer, rheology modifier, anti-redeposition polymer, chelating agent, fragrance, bitterant, and any combination thereof. In some aspects, the additives can be a combination of a surfactant, water, enzyme, performance polymer, rheology modifier, anti-redeposition polymer, chelating agent, and bitterant. In some aspects, the additives can be a combination of a surfactant, water, enzyme, performance polymer, rheology modifier, anti-redeposition polymer, and bitterant. In some aspects, the additives can be a combination of anionic and nonionic surfactants. In some aspects, the additive can be a fragrance (e.g., an encapsulated fragrance), particularly in aspects in which the powder composition comprises a surfactant.

In some aspects, the liquid composition comprises from about 10 wt % to about 90 wt % of a total amount of additives relative to the total weight of the liquid composition. For example, the total amount of additives can be from about 10 wt % to about 85 wt %, about 10 wt % to about 80 wt %, about 10 wt % to about 75 wt %, about 10 wt % to about 70 wt %, about 10 wt % to about 65 wt %, about 10 wt % to about 60 wt %, about 10 wt % to about 55 wt %, about 10 wt % to about 50 wt %, about 10 wt % to about 45 wt %, about 10 wt % to about 40 wt %, about 10 wt % to about 35 wt %, about 10 wt % to about 30 wt %, about 10 wt % to about 25 wt %, about 10 wt % to about 20 wt %, about 10 wt % to about 15 wt %, about 15 wt % to about 90 wt %, about 15 wt % to about 85 wt %, about 15 wt % to about 80 wt %, about 15 wt % to about 75 wt %, about 15 wt % to about 70 wt %, about 15 wt % to about 65 wt %, about 15 wt % to about 60 wt %, about 15 wt % to about 55 wt %, about 15 wt % to about 50 wt %, about 15 wt % to about 45 wt %, about 15 wt % to about 40 wt %, about 15 wt % to about 35 wt %, about 15 wt % to about 30 wt %, about 15 wt % to about 25 wt %, about 15 wt % to about 20 wt %, about 20 wt % to about 90 wt %, about 20 wt % to about 85 wt %, about 20 wt % to about 80 wt %, about 20 wt % to about 75 wt %, about 20 wt % to about 70 wt %, about 20 wt % to about 65 wt %, about 20 wt % to about 60 wt %, about wt % to about 55 wt %, about 20 wt % to about 50 wt %, about 20 wt % to about 45 wt %, about 20 wt % to about 40 wt %, about 20 wt % to about 35 wt %, about 20 wt % to about 30 wt %, about 20 wt % to about 25 wt %, about 25 wt % to about 90 wt %, about 25 wt % to about 85 wt %, about wt % to about 80 wt %, about 25 wt % to about 75 wt %, about 25 wt % to about 70 wt %, about wt % to about 65 wt %, about 25 wt % to about 60 wt %, about 25 wt % to about 55 wt %, about wt % to about 50 wt %, about 25 wt % to about 45 wt %, about 25 wt % to about 40 wt %, about 25 wt % to about 35 wt %, about 25 wt % to about 30 wt %, about 30 wt % to about 90 wt %, about wt % to about 85 wt %, about 30 wt % to about 80 wt %, about 30 wt % to about 75 wt %, about wt % to about 70 wt %, about 30 wt % to about 65 wt %, about 30 wt % to about 60 wt %, about wt % to about 55 wt %, about 30 wt % to about 50 wt %, about 30 wt % to about 45 wt %, about wt % to about 40 wt %, about 30 wt % to about 35 wt %, about 35 wt % to about 90 wt %, about 35 wt % to about 85 wt %, about 35 wt % to about 80 wt %, about 35 wt % to about 75 wt %, about wt % to about 70 wt %, about 35 wt % to about 65 wt %, about 35 wt % to about 60 wt %, about wt % to about 55 wt %, about 35 wt % to about 50 wt %, about 35 wt % to about 45 wt %, about wt % to about 40 wt %, about 40 wt % to about 90 wt %, about 40 wt % to about 85 wt %, about 40 wt % to about 80 wt %, about 40 wt % to about 75 wt %, about 40 wt % to about 70 wt %, about 40 wt % to about 65 wt %, about 40 wt % to about 60 wt %, about 40 wt % to about 55 wt %, about wt % to about 50 wt %, about 40 wt % to about 45 wt %, about 45 wt % to about 90 wt %, about 45 wt % to about 85 wt %, about 45 wt % to about 80 wt %, about 45 wt % to about 75 wt %, about 45 wt % to about 70 wt %, about 45 wt % to about 65 wt %, about 45 wt % to about 60 wt %, about 45 wt % to about 55 wt %, about 45 wt % to about 50 wt %, about 50 wt % to about 90 wt %, about 50 wt % to about 85 wt %, about 50 wt % to about 80 wt %, about 50 wt % to about 75 wt %, about 50 wt % to about 70 wt %, about 50 wt % to about 65 wt %, about 50 wt % to about 60 wt %, about 50 wt % to about 55 wt %, about 55 wt % to about 90 wt %, about 55 wt % to about 85 wt %, about 55 wt % to about 80 wt %, about 55 wt % to about 75 wt %, about 60 wt % to about 90 wt %, about 60 wt % to about 85 wt %, about 60 wt % to about 80 wt %, about 60 wt % to about 75 wt %, about 60 wt % to about 72 wt %, about 60 wt % to about 70 wt, about 65 wt % to about 90 wt %, about 65 wt % to about 85 wt %, about 65 wt % to about 80 wt %, about 65 wt % to about 75 wt %, about 65 wt % to about 72 wt %, about 65 wt % to about 70 wt, about 70 wt % to about 90 wt %, about 70 wt % to about 85 wt %, about 70 wt % to about 80 wt %, about 70 wt % to about 75 wt %, about 70 wt % to about 72 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, about 80 wt % about 81 wt %, about 82 wt %, about 83 wt %, about 84 wt %, about 85 wt %, about 86 wt %, about 87 wt %, about 88 wt %, about 89 wt %, or about 90 wt %, of the total weight of the liquid composition.

In some aspects, the additive in the liquid composition is a surfactant, particularly in instances when the powder composition does not comprise a surfactant. In some aspects, the surfactant is an anionic surfactant, a cationic surfactant, a zwitterionic surfactant, a nonionic surfactant, or any combination thereof. For example, the liquid composition can comprise an anionic surfactant, a nonionic surfactant, or a combination of one or more thereof. In some aspects, the liquid composition comprises a combination of at least one anionic surfactant and at least one nonionic surfactant.

The anionic surfactant comprises a hydrophobic tail group (e.g., a linear aliphatic chain) and an anionic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl), alkyl, or fluoro (e.g., perfluorinated). The anionic hydrophilic group can be, for example, a sulfate (—OSO₃⁻), sulfonate (—SO₃⁻), a phosphate (—OPO₃³⁻), a carboxylate (—C(O)O—), or the conjugate base of an organic acid. In some aspects, polyethylene glycol repeat units designated as “ether” can be disposed between the hydrophobic tail group (e.g., a fatty group) and hydrophilic head group.

In some aspects, the anionic surfactant comprises an alkyl sulfate (e.g., a monoethanolamine salt of a linear alkylbenzene sulfonate (MEA-LAS), a distyrylbiphenyl disulfonate, an alkylether sulfate), an alkyl sulfonate, a fatty acid salt (e.g., a cocoate), a bile acid salt, a glutamic acid salt, a cholic acid salt, a carboxylic poly(ethylene glycol) ether, a taurate, or a combination thereof. Typically, the salt will be a Group I (e.g., lithium, sodium, potassium, etc.), Group II (e.g., magnesium, calcium, etc.), or ammonium salt.

Examples of an alkyl sulfate include, e.g., a fatty sulfate (e.g., octylsulfate, decyl sulfate, lauryl(dodecyl) sulfate, myristyl sulfate), dioctyl sodium sulfosuccinate, and an alkyl ether sulfate (also called an alcohol ethoxysulfate)). Other examples of fatty sulfate include, e.g., 3-sulfopropyl ethoxylate laurylphenyl ether and coco (coconut fatty acid) sulfate. Examples of an alkyl sulfonate include, e.g., a linear alkylbenzene sulfonate (e.g., sodium laurylbenzene sulfonate), a perfluoroalkyl sulfonate (e.g., perfluorooctyl sulfonate, perfluorobutyl sulfonate), a methyl ester sulfonate, and a distyrylbiphenyl disulfonate (e.g., disodium distyrylbiphenyl disulfonate).

A cocoate (e.g., sodium cocoate) is a fatty acid salt of coconut oil. In an aspect, the cocoate (fatty acid salt) can have the structure R′—C(═O)O—X⁺, wherein R′ is a C₇-C₁₇ alkyl group, and X⁺ is a cation that balances the charge of the carboxylate. The C₇-C₁₇ alkyl group is an alkyl comprising 7 to 17 carbons (e.g., 7 to 16 carbons, 7 to 14 carbons, 7 to 12 carbons, 8 to 17 carbons, 8 to 16 carbons, 10 to 17 carbons, 10 to 16 carbons, 12 to 17 carbons, or 12 to 16 carbons, such as C₇ alkyl, C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, or C₁₇ alkyl). The cation, X⁺, can be, for example, a cation with a +1 or +2 charge. Suitable examples of X⁺ include a Group I cation (e.g., sodium cation, potassium cation), a Group II cation (e.g., magnesium cation, calcium cation), an ammonium cation, or any combination thereof. In some aspects, X⁺ is Group I cation, such as a sodium cation. Examples of a fatty acid salt include, e.g., a caprylate, a laurate, a palmitate, a myristate, and a stearate.

Other anionic surfactants include a bile acid salt, a glutamic acid salt (e.g., N-myristoyl-1-glutamic acid), a glycolic acid salt, a cholic acid salt, a carboxylic poly(ethylene glycol) ether (e.g., glycolic acid ethoxylate laurylphenyl ether, glycolic acid ethoxylate oleyl ether), a taurate (e.g., sodium oleic acid methyl taurate, sodium coconut fatty acid methyl taurate, sodium cocyl methyl taurate), or any combination thereof.

In some aspects, the anionic surfactant comprises an alkyl ether sulfate (AES). In general, the AES will have the structure R⁴—O-(EO).SO₃⁻X⁺, in which R⁴ is a C₈-C₁₈ alkyl group (linear or branched), EO is polyethoxylate, n is typically 1 to 8 (e.g., 1, 2, 3, 4, 5, 6, 7, or 8), and X⁺ is a cation that balances the charge of the sulfonate. The C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₈ alkyl). In some aspects, the cation X⁺ can be a Group I cation, such as sodium cation or potassium cation, particularly sodium cation. In some aspects, the AES is sodium laureth sulfate.

In some aspects, the anionic surfactant comprises a linear alkylbenzene sulfonate (LAS). In some aspects, the LAS in the liquid composition is of Formula (I).

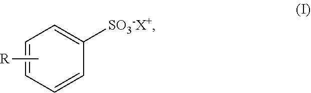

in which R is a linear C₁₀-C₁₈ (e.g., C₁₀, C₁₁, C₁₂, C₁₃, C₁₄, C₁₅, C₁₆, C₁₇, and C₁₈)alkyl, and X⁺ is a cation that balances the charge of the sulfonate. The cation, X⁺, can be, for example, a cation with a +1 or +2 charge. Suitable examples of X⁺ include a Group I cation (e.g., sodium cation, potassium cation), a Group II cation (e.g., magnesium cation, calcium cation), an ammonium cation, or any combination thereof. In some aspects, X⁺ is Group I cation, such as a sodium cation. The phenylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some aspects, the alkyl R and sulfonate are para to one another.

In some aspects, the LAS is a monoethanolamine salt of a linear alkylbenzene sulfonate (MEA-LAS), such as a monoethanolamine salt of a C₁₀-C₁₆ alkylbenzene sulfonate (e.g., MEA laureth sulfate).

In some aspects, the liquid composition does not comprise or is substantially free of a linear alkylbenzene sulfonate (LAS).

In some aspects, the anionic surfactant comprises a cocoate (i.e., a fatty acid salt), a monoethanolamine salt of a linear alkylbenzene sulfonate (MEA-LAS), an alkylether sulfate, a distyrylbiphenyl disulfonate, and any combination thereof.

A cationic surfactant comprises a hydrophobic tail group (e.g., a linear aliphatic chain) and a cationic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic hydrophilic group can be, for example, an amino group that can be quaternized, such as trialkylammonium. The counterion can be any suitable anion that can balance the charge. In some aspects, the counterion is an anion with a −1 charge (e.g., X⁻), such as a halide (e.g., chloride, bromide, etc.), hydroxy, or tosylate.

In some aspects, the cationic surfactant can be a fatty amine salt or a quaternary ammonium compound. In some aspects, the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or any combination thereof. Examples of the fatty amine salt include, e.g., a C₈-C₁₈ fatty amine salt (e.g., R⁵—NH₃⁺, in which R⁵ is a C₈-C₁₈ alkyl group). Examples of a fatty diamine salt include, e.g., R⁵—NH₂⁺—R⁶—NH₃⁺, in which R⁵ is a C₈-C₁₈ alkyl group and R⁶ is a C₁₋₆ alkyl. Examples of an alkoxylated amine and an alkoxylated diamine include a polyethoxylated fatty amine and diamine, respectively. Examples of a fatty quaternary ammonium compound include, e.g., R⁷—NR⁸₃⁺, in which R⁷ is a C₈-C₁₈ alkyl group and each R⁸ is a C₁₋₄ alkyl, phenyl, or benzyl (e.g., alkyltrimethylammonium halide, alkyltrimethylammonium tosylate, alkyltrimethylammonium hydroxide). Examples of a fatty amide quaternary ammonium compound include, e.g., R⁹—C(O)N-R¹⁰-NR¹¹₃⁺, in which R⁹ is a C₈-C₁₈ alkyl group, R¹⁰ is a C₁₋₆ alkyl, and each R¹¹ is a C₁₋₄ alkyl, phenyl, or benzyl (e.g., trimethylammonium stearamide). Examples of an alkoxylated quaternary ammonium compound include, e.g., a polyethoxylated quaternary ammonium compound. Examples of a benzalkyl quaternary ammonium compound include, e.g., benzyl-C₈-C₁₈ alkyldimethylammonium (e.g., benzalkonium chloride). In any of the foregoing examples, the C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₅ alkyl). The C₇-C₁₇ alkyl group is an alkyl comprising 7 to 17 carbons (e.g., 7 to 16 carbons, 7 to 14 carbons, 7 to 12 carbons, 8 to 17 carbons, 8 to 16 carbons, 10 to 17 carbons, 10 to 16 carbons, 12 to 17 carbons, or 12 to 16 carbons, such as C₇ alkyl, C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, or C₁₇ alkyl).

In some aspects, the cationic surfactant can be alkoxylated, in which polyalkylene glycol (e.g., polyethylene glycol, polypropylene glycol) repeat units can be disposed between the hydrophobic tail group (e.g., a fatty group) and hydrophilic head group.

The zwitterionic surfactant is amphoteric and comprises a hydrophobic tail group (e.g., a linear aliphatic chain) and a hydrophilic head group with both a cationic charge and an anionic charge. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic moiety can be, for example, a quaternary ammonium group, such as dialkylammonium or trialkylammonium (e.g., C₁-C₄ alkyl, such as methyl). The anionic moiety can be, for example, oxo (O⁻), a sulfate (—OSO₃⁻), sulfonate (—SO₃⁻), a phosphate (—OPO₃₃—), a carboxylate (—C(O)O—), or the conjugate base of an organic acid.

In some aspects, the zwitterionic surfactant comprises a betaine, a sulfonated quaternary ammonium compound, a phosphonated quaternary ammonium compound, a trialkylamine N-oxide, or any combination thereof.

Examples of a betaine include, e.g., C₈-C₁₈ alkyl betaine, cocobetaine, cocamidopropyl betaine, amidosulfobetaine-16, hexadecyl hydroxypropyl sulfobetaine, lauryl-N,N-(dimethylammonio)butyrate, and lauryl-N,N-(dimethyl)-glycinebetaine. Examples of a sulfonated quaternary ammonium compound include, e.g., 3-(N,N-dimethyl-octylammonio)propanesulfonate, 4-(N,N-dimethyl-dodecylammonio)butanesulfonate, 3-{N,N-dimethyl-N-[3-(4-octylbenzoylamino)propyl]ammonio}propanesulfonate, 3⁻[(3-cholamidopropyl)dimethylammonio]-1-propanesulfonate, 3-([3-cholamidopropyl]dimethylammonio)-2-hydroxy-1-propanesulfonate, coco(amidopropyl)dimethylammonio-2-hydroxypropanesulonate, lauryl-N,N-(dimethylammonio)butyrate, lauryl-N,N-(dimethyl)-propanesulfonate, 3-(4-tert-butyl-1-pyridinio)-1-propanesulfonate, 3-(1-pyridinio)-1-propanesulfonate, and 3-(benzyl-dimethylammonio)propanesulfonate. Examples of a phosphonated quaternary ammonium compound include, e.g., a phosphocholine, such as N-dodecylphosphocholine and hexadecyl phosphocholine. Examples of a trialkylamine N-oxide include, e.g., R⁴—N(O⁻)R⁵₂⁺, in which R⁴ is a C₈-C₁₈ alkyl group, R⁵ is a C₁₋₄ alkyl, such as lauryldimethylamine N-oxide and 4-ethyl-N,N-2-trimethyloctan-1-amine oxide.

A nonionic surfactant comprises a hydrophobic tail group (e.g., a linear aliphatic chain) and an uncharged (i.e., neutral) hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The uncharged hydrophilic group can be, for example, an alkoxylate, such as ethoxylate ((—CH₂CH₂O—)ₙ; EO or PEO) or propoxylate ((—CH(CH₃)CH₂O—)ₘ; PO or PPO), in which n and m are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3,4, 5, 6,7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

In some aspects, the nonionic surfactant comprises a cocamide monethanolamine (cocamide MEA), a methyl ester ethoxylate, an alcohol alkoxylate, a fatty acid alkoxylate, an alkyl phenol ethoxylate, an alkoxylated amine, an alkyl glucoside, a fatty amide alkoxylate, a diester of alkoxylated fatty acid, a glycerol fatty ester, castor oil alkoxylate, an ethylene oxide-propylene oxide block copolymer, a phenol alkoxylate, or a combination thereof.

A cocamide monethanolamine (cocamide MEA) is a mixture of fatty acid amides produced from the fatty acids in coconut oil when reacted with ethanolamine.

Examples of an alcohol alkoxylate include, e.g., C₈-C₁₈ ethoxylate and C₈-C₁₈ propoxylate. Examples of a fatty acid alkoxylate include, e.g., R¹²—C(O)O-EO-H, in which R¹² is a C₇-C₁₇ alkyl group and EO is polyethoxylate. Examples of an alkyl phenol ethoxylate include, e.g., R¹²-phenyl-O(EO)-H, in which R¹² is a C₈-C₁₈ alkyl group and EO is polyethoxylate. Examples of an alkoxylated amine include, e.g., ethoxylated C₈-C₁₈ alkylamine, tallow amine ethoxylate, lauryl amine ethoxylate ether, 2-2-(2-hydroxyethoxy)ethylaminoethanol, bis(hydroxyethoxyethyl)amine, 2,2′-((2-(2-hydroxyethoxy)ethyl)azanediyl)diethanol, and coco bis(2-hydroxyethyl)amine. Example of an alkyl glucoside include, e.g., alkyl polyglucoside, such as C₈-C₁₈ polyglucoside which can include 1 to 3 glucoside units. Examples of a fatty amide alkoxylate include R¹³—C(O)NH-(EO)-H, in which R¹³ is a C₇-C₁₇ alkyl group and EO is polyethoxylate. Examples of a diester of alkoxylated fatty acid include, e.g., R¹⁴—C(O)O-EO—C(O)—R^{14′}, in which R¹⁴ and R^{14′} is a C₇-C₁₇ alkyl group and EO is polyethoxylate. Examples of an alkoxylated methyl ester of fatty acid (e.g., a methyl ester ethoxylate) include e.g., R¹⁵—C(O)O-EO-R¹⁶, in which R¹⁵ is a C₇-C₁₇ alkyl group, R¹⁶ is a C₁-C₄ alkyl group, and EO is polyethoxylate. Examples of a glycerol fatty ester include, e.g., an ester formed from glycerol and a fatty acid (e.g., C₈-C₁₈ alkyl), such as 2-ethylhexyl oleate, glycerol trioleate, glyceryl monooleate, glyceryl monotallate, n-butyl stearate, neopentylglycol dioleate, pentaerythritol monooleate, pentaerythritol tetraoleate, and trimethylolpropane trioleate. An example of a castor oil alkoxylate is polyethoxylated castor oil. Examples of an ethylene oxide-propylene oxide block copolymer include, e.g., R¹⁷O-(EO)ₙ-(PO)ₘ-(EO)ₙ—R¹⁸, in which R¹⁷ and R¹⁸ are the same or different and each is a C₁-C₇ alkyl, a C₅-C₆ cycloalkyl, or an aryl; n is an integer of 30-150 (e.g., about 40-135, about 42-133), and m is an integer of about 10-100 (e.g., about 10-80, about 20-70, about 21-68) and block copolymers such as, PEO-PPO-PEO and PPO-PEO-PPO. Examples of a phenol alkoxylate include, e.g., R⁵—C₆H₄-(EO)-H, wherein R⁵ is hydrogen or a C₁-C₁₅ alkyl group, and EO is polyethoxylate, such as octyphenol ethoxylate, nonylphenol ethoxylate, 2-phenoxydecan-1-ol, bisphenol ethoxylate, and a styrenated phenol ethoxylate (e.g., tristyrylphenol ethoxylate). In any of the foregoing examples, the C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₅ alkyl). The C₇-C₁₇ alkyl group is an alkyl comprising 7 to 17 carbons (e.g., 7 to 16 carbons, 7 to 14 carbons, 7 to 12 carbons, 8 to 17 carbons, 8 to 16 carbons, 10 to 17 carbons, 10 to 16 carbons, 12 to 17 carbons, or 12 to 16 carbons, such as C₇ alkyl, C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, or C₁₇ alkyl).

In general, the alcohol ethoxylate (AE) will have a chemical structure of formula (II):

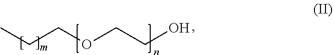

in which m is an integer of 10 to 16 (e.g., 10, 11, 12, 13, 14, 15, or 16) to form a C₁₂-C₁₈ fatty alkyl (e.g., C₁₂, C₁₃, C₁₄, C₁₅, C₁₆, C₁₇, and C₁₈), and n is an integer of 1 to 15 (e.g., 1, 2, 3, 4, 5, 6, 7, 8, 9, 10, 11, 12, 13, 14, or 15). The alcohol ethoxylate typically will contain a range of alkyl groups, such as C₁₂-C₁₅ or C₁₂-C₁₄ and can contain branches. In some aspects, the fatty alcohol ethoxylate can contain 1 to 15 moles (e.g., 1 to 12 moles, 1 to 9 moles, 1 to 7 moles, or about 7 moles) of ethoxylate per mole of alcohol. In some aspects, the fatty alcohol ethoxylate can be a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate. In some aspects, the alcohol ethoxylate comprises ethoxylated lauryl alcohol.

In some aspects, the methyl ester ethoxylate (MEE) can be of the formula: R¹⁹—C(═O)O-(EO)ₙ-CH₃, wherein R¹⁹ is a C₈-C₂₄ alkyl group, EO is polyethoxylate, and n is an integer of moles from 5 to 30 (i.e., n is 5, 6, 7, 8, 9, 10, 11, 12, 13, 14, 15, 16, 17, 18, 19, 20, 21, 22, 23, 24, 25, 26, 27, 28, 29, or 30). The C₈-C₂₄ alkyl group is an alkyl comprising 8 to 24 carbons (e.g., 8 to 22 carbons, 8 to 20 carbons, 8 to 18 carbons, 8 to 16 carbons, 10 to 24 carbons, 10 to 22 carbons, 10 to 20 carbons, 10 to 18 carbons, 10 to 16 carbons, 12 to 24 carbons, 12 to 22 carbons, 12 to 20 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, C₁₈ alkyl, C₁₉ alkyl, C₂₀ alkyl, C₂₁ alkyl, C₂₂ alkyl, C₂₃ alkyl, or C₂₄ alkyl). In some aspects, the MEE is of formula R¹⁹—C(═O)O-(EO)ₙ-CH₃, in which R¹⁹ is C₁₇ alkyl, and n is 10.

In some aspects, the liquid composition comprises at least one surfactant selected from a cocamide monethanolamine (MEA-cocoate), a cocoate, a monoethanolamine salt of a linear alkylbenzene sulfonate (MEA-LAS), an alkylether sulfate, a distyrylbiphenyl disulfonate, and any combination thereof.

In some aspects, the liquid composition comprises from about 10 wt % to about 65 wt % of a surfactant relative to the total weight of the liquid composition. For example, the total surfactant content can be from about 10 wt % to about 60 wt %, about 10 wt % to about 58 wt %, about 10 wt % to about 55 wt %, about 10 wt % to about 52 wt %, about 10 wt % to about 50 wt %, about 10 wt % to about 48 wt %, about 10 wt % to about 45 wt %, about 10 wt % to about 42 wt %, about 10 wt % to about 40 wt %, about 10 wt % to about 35 wt %, about 10 wt % to about 30 wt %, about 10 wt % to about 25 wt %, about 10 wt % to about 20 wt %, about 10 wt % to about 18 wt %, about 10 wt % to about 15 wt %, about 15 wt % to about 65 wt %, about 15 wt % to about 60 wt %, about 15 wt % to about 58 wt %, about 15 wt % to about 55 wt %, about 15 wt % to about 52 wt %, about 15 wt % to about 50 wt %, about 15 wt % to about 48 wt %, about 15 wt % to about 45 wt %, about 15 wt % to about 42 wt %, about 15 wt % to about 40 wt %, about 15 wt % to about 35 wt %, about 15 wt % to about 30 wt %, about 15 wt % to about 25 wt %, about 15 wt % to about 20 wt %, about 15 wt % to about 18 wt %, about 20 wt % to about 65 wt %, about 20 wt % to about 60 wt %, about 20 wt % to about 58 wt %, about 20 wt % to about 55 wt %, about 20 wt % to about 52 wt %, about 20 wt % to about 50 wt %, about 20 wt % to about 48 wt %, about 20 wt % to about 45 wt %, about 20 wt % to about 42 wt %, about 20 wt % to about 40 wt %, about 20 wt % to about 35 wt %, about 20 wt % to about 30 wt %, about 20 wt % to about 25 wt %, about 25 wt % to about 65 wt %, about 25 wt % to about 60 wt %, about 25 wt % to about 58 wt %, about 25 wt % to about 55 wt %, about 25 wt % to about 52 wt %, about 25 wt % to about 50 wt %, about 25 wt % to about 48 wt %, about 25 wt % to about 45 wt %, about 25 wt % to about 42 wt %, about 25 wt % to about 40 wt %, about 25 wt % to about 35 wt %, about 25 wt % to about 30 wt %, about 28 wt % to about 65 wt %, about 28 wt % to about 60 wt %, about 28 wt % to about 58 wt %, about 28 wt % to about 55 wt %, about 28 wt % to about 52 wt %, about 28 wt % to about 50 wt %, about 28 wt % to about 48 wt %, about 28 wt % to about 45 wt %, about 28 wt % to about 42 wt %, about 28 wt % to about 40 wt %, about 28 wt % to about 35 wt %, about 28 wt % to about 30 wt %, about 30 wt % to about 65 wt %, about 30 wt % to about 60 wt %, about 30 wt % to about 58 wt %, about 30 wt % to about 55 wt %, about 30 wt % to about 52 wt %, about 30 wt % to about 50 wt %, about 30 wt % to about 48 wt %, about 30 wt % to about 45 wt %, about 30 wt % to about 42 wt %, about 30 wt % to about 40 wt %, about 30 wt % to about 35 wt %, about 32 wt % to about 65 wt %, about 32 wt % to about 60 wt %, about 32 wt % to about 58 wt %, about 32 wt % to about 55 wt %, about 32 wt % to about 52 wt %, about 32 wt % to about 50 wt %, about 32 wt % to about 48 wt %, about 32 wt % to about 45 wt %, about 32 wt % to about 42 wt %, about 32 wt % to about 40 wt %, about 32 wt % to about 35 wt %, about 35 wt % to about 60 wt %, about 35 wt % to about 58 wt %, about 35 wt % to about 55 wt %, about 35 wt % to about 52 wt %, about 35 wt % to about 50 wt %, about 35 wt % to about 48 wt %, about 35 wt % to about 45 wt %, about 35 wt % to about 42 wt %, about 35 wt % to about 40 wt %, about 38 wt % to about 65 wt %, about 38 wt % to about 60 wt %, about 38 wt % to about 58 wt %, about 38 wt % to about 55 wt %, about 38 wt % to about 52 wt %, about 38 wt % to about 50 wt %, about 38 wt % to about 48 wt %, about 38 wt % to about 45 wt %, about 38 wt % to about 42 wt %, about 38 wt % to about 40 wt %, about 40 wt % to about 65 wt %, about 40 wt % to about 60 wt %, about 40 wt % to about 58 wt %, about 40 wt % to about 55 wt %, about 40 wt % to about 52 wt %, about 40 wt % to about 50 wt %, about 40 wt % to about 48 wt %, about 40 wt % to about 45 wt %, about 40 wt % to about 42 wt %, about 42 wt % to about 65 wt %, about 42 wt % to about 60 wt %, about 42 wt % to about 58 wt %, about 42 wt % to about 55 wt %, about 42 wt % to about 52 wt %, about 42 wt % to about 50 wt %, about 42 wt % to about 48 wt %, about 42 wt % to about 45 wt %, about 45 wt % to about 65 wt %, about 45 wt % to about 60 wt %, about 45 wt % to about 58 wt %, about 45 wt % to about 55 wt %, about 45 wt % to about 52 wt %, about 45 wt % to about 50 wt %, about 45 wt % to about 48 wt %, about 48 wt % to about 65 wt %, about 48 wt % to about 60 wt %, about 48 wt % to about 58 wt %, about 48 wt % to about 55 wt %, about 48 wt % to about 52 wt %, about 48 wt % to about 50 wt %, about 50 wt % to about 65 wt %, about 50 wt % to about 60 wt %, about 50 wt % to about 58 wt %, about 50 wt % to about 55 wt %, about 50 wt % to about 52 wt %, about 52 wt % to about 65 wt %, about 52 wt % to about 60 wt %, about 52 wt % to about 58 wt %, about 52 wt % to about 55 wt %, about 55 wt % to about 65 wt %, about 55 wt % to about 60 wt %, about 55 wt % to about 58 wt %, about 58 wt % to about 65 wt %, about 58 wt % to about 60 wt %, about 60 wt % to about 65 wt %, about 65 wt %, about 64 wt %, about 63 wt %, about 62 wt %, about 61 wt %, about 60 wt %, about 59 wt %, about 58 wt %, about 57 wt %, about 56 wt %, about 55 wt %, about 54 wt %, about 53 wt %, about 52 wt %, about 51 wt %, about 50 wt %, about 49 wt %, about 48 wt %, about 47 wt %, about 46 wt %, about 45 wt %, about 44 wt %, about 43 wt %, about 42 wt %, about 41 wt %, about 40 wt %, about 39 wt %, about 38 wt %, about 37 wt %, about 36 wt %, about 35 wt %, about 34 wt %, about 33 wt %, about 32 wt %, about 31 wt %, about 30 wt %, about 29 wt %, about 28 wt %, about 27 wt %, about 26 wt %, about 25 wt %, about 24 wt %, about 23 wt %, about 22 wt %, about 21 wt %, about 20 wt %, about 19 wt %, about 18 wt %, about 17 wt %, about 16 wt %, about 15 wt %, about 14 wt %, about 13 wt %, about 12 wt %, about 11 wt %, or about 10 wt % of the total weight of the liquid composition.

In some aspects, the liquid composition comprises water as an additive. In some aspects, the liquid composition comprises from about 1 wt % to about 20 wt % of water relative to the total weight of the liquid composition. For example, the water content can be present in an amount from about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 2 wt % to about 20 wt %, about 2 wt % to about 18 wt %, about 2 wt % to about 15 wt %, about 2 wt % to about 12 wt %, about 2 wt % to about 10 wt %, about 2 wt % to about 8 wt %, about 2 wt % to about 5 wt %, about 2 wt % to about 3 wt %, about 5 wt % to about 20 wt %, about 5 wt % to about 18 wt %, about 5 wt % to about 15 wt %, about 5 wt % to about 12 wt %, about 5 wt % to about 10 wt %, about 5 wt % to about 8 wt %, about 10 wt % to about 20 wt %, about 10 wt % to about 18 wt %, about 10 wt % to about 15 wt %, about 10 wt % to about 12 wt %, about 12 wt % to about 20 wt %, about 12 wt % to about 18 wt %, about 12 wt % to about 15 wt %, about 15 wt % to about 20 wt %, about 15 wt % to about 18 wt %, about 20 wt %, about 19 wt %, about 18 wt %, about 17 wt %, about 16 wt %, about 15 wt %, about 14 wt %, about 13 wt %, about 12 wt %, about 11 wt %, about 10 wt %, about 9 wt %, about 8 wt %, about 7 wt %, about 6 wt %, about 5 wt %, about 4 wt %, about 3 wt %, about 2 wt %, or about 1 wt % of the total weight of the liquid composition. In some aspects, the liquid composition comprises about 1 wt % to about 10 wt % or about 3 wt % to about 8 wt % water.

In some aspects, the liquid composition does not include water (i.e., is substantially free of water). In some aspects, the liquid composition does not comprise added water but includes water as part of another component, such as water from an encapsulated fragrance.

In some aspects, the liquid composition comprises an enzyme to aid in removing stains, including protein stains, oil stains, tannin stains, starch stains, and dyes. For example, a protease is capable of breaking down protein-based stains, such as sweat, blood, mud, and dairy products. An amylase is capable of breaking down a starch-based stain, such as cornstarch or potato starch. A lipase is capable of breaking down fats. A mannanase is capable of breaking down guar and locust bean stains. In some aspects, the at least one enzyme is a hydrolytic enzyme. The at least one enzyme can comprise a protease, an amylase, a mannanase, a lactase, a lipase, a perhydrolase, an oxidoreductase, an endocellulase, an exocellulase, or a combination thereof. In some aspects, the liquid composition comprises a protease, an amylase, a mannanase, or a combination thereof.

In some aspects, the liquid composition comprises a total from about 0.1 wt % to about 8 wt % of at least one enzyme (e.g., a protease, an amylase, a mannanase, or a combination thereof) relative to the total weight of the liquid composition. For example, the total enzyme content can be from about 0.1 wt % to about 6 wt %, about 0.1 wt % to about 5 wt %, about 0.1 wt % to about 3 wt %, about 0.1 wt % to about 2 wt %, about 0.1 wt % to about 1 wt %, about 0.5 wt % to about 8 wt %, 0.5 wt % to about 6 wt %, about 0.5 wt % to about 5 wt %, about 0.5 wt % to about 3 wt %, about 0.5 wt % to about 2 wt %, about 0.5 wt % to about 1 wt %, about 1 wt % to about 8 wt %, about 1 wt % to about 6 wt %, about 1 wt % to about 5 wt %, about 1 wt % to about 4 wt %, about 1 wt % to about 3 wt %, about 1 wt % to about 2 wt %, about 2 wt % to about 8 wt %, about 2 wt % to about 6 wt %, about 2 wt % to about 5 wt %, about 2 wt % to about 4 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, about 5 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, or about 8 wt % of the total weight of the liquid composition.

In some aspects, the liquid composition comprises a performance polymer as an additive, in which the performance polymer improves at least one aspect of a washed textile. In some aspects, the performance polymer improves the cleaning action of the detergent composition, removes or reduces stains, maintains whiteness, protects color, protects the integrity of a textile, provides odor control, or any combination thereof. In some aspects the performance polymer comprises polyethyleneimine ethoxylate, polyethyleneimine ethoxylate propoxylate, a polycarboxylate (e.g., an acrylic homopolymer or copolymer), carboxymethylcellulose, a polyester, polyvinyl pyrrolidone, a copolymer comprising terephthalic acid, a copolymer comprising maleic acid, a copolymer comprising acrylamino tertiary butyl sulfonate, or any combination thereof. In some aspects the performance polymer comprises an alkoxylated polyethyleneimine, such as polyethyleneimine ethoxylate, polyethyleneimine ethoxylate propoxylate, or a combination of both.

In some aspects, the liquid composition comprises from about 0.5 wt % to about 10 wt % of a performance polymer relative to the total weight of the liquid composition. For example, the performance polymer content can be from about 0.5 wt % to about 8 wt %, about 0.5 wt % to about 5 wt %, about 0.5 wt % to about 3 wt %, about 0.5 wt % to about 2 wt %, about 0.5 wt % to about 1 wt %, about 1 wt % to about 10 wt %, about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the liquid composition.

In some aspects, the liquid composition comprises a rheology modifier as an additive. Typically, the rheology modifier is a polymer that swells in the presence of water and other solvents. Some rheology modifiers contain acid groups and require neutralization to become activated. Once activated, the rheology modifier increases the viscosity of the liquid composition. Suitable examples of a rheology modifier include, for example, an acrylic polymer or copolymer (e.g., an acid-containing, cross-linked acrylic emulsion copolymer, a cross-linked polyacrylic acid, an acrylic acid-alkyl acrylate copolymer, a hydrophobically-modifiedpolyacrylate crosspolymer, quaternizedpolyacrylic acid), an Alkali Soluble Emulsion (ASE) polymer, a Hydrophobically Modified Alkali Soluble Emulsion (HASE) polymer, or any combination thereof. An ASE or HASE polymer typically is a carboxyl-containing copolymer prepared by the addition polymerization of ethylenically unsaturated monomers. ASE polymers are either alkali-swellable or alkali-soluble emulsions. A HASE polymer is an ASE polymer that has been modified with hydrophobic groups.

In some aspects, the rheology modifier is an acrylic-based polymer, such as a carbomer. In some aspects, the rheology modifier is a copolymer comprising acrylic acid monomer units and alkyl acrylate monomer units.

In some aspects, the rheology modifier is a HASE polymer. In some aspects, the HASE polymer has the following structure:

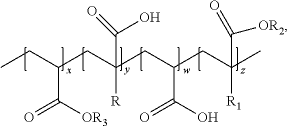

wherein R, R₁, and R₃ are independently selected from H and C₁-1o alkyl groups, R₂ is an optionally alkoxylated C₁₋₂₀ alkyl group, and w, x, y and z are integers.

In some aspects, R and R₁ are independently selected from C₁₋₁₀ alkyl groups, R₂ is an ethoxylated C₁₋₂₀ alkyl group, and R₃ is H or a C₁₋₆ alkyl. In some aspects, R and R₁ are methyl groups, R₂ is an ethoxylated C₈₋₂₀ alkyl group, and R₃ is an ethyl group. In some aspects, the repeating units comprising R, R₁, R₂, and R₃ can be in any suitable order, or even randomly distributed through the polymer chain.

In some aspects, the HASE polymer can have a molecular weight of about 50,000 to about 500,000 g/mol, about 80,000 to about 400,000 g/mol, about 100,000 to about 300,000 g/mol, about 50,000 to about 450,000 g/mol, about 50,000 to about 400,000 g/mol, about 50,000 to about 350,000 g/mol, about 50,000 to about 300,000 g/mol, about 50,000 to about 250,000 g/mol, about 50,000 to about 200,000 g/mol, about 50,000 to about 150,000 g/mol, about 50,000 to about 100,000 g/mol, about 100,000 to about 500,000 g/mol, about 150,000 to about 500,000 g/mol, about 200,000 to about 500,000 g/mol, about 250,000 to about 500,000 g/mol, about 300,000 to about 500,000 g/mol, about 350,000 to about 500,000 g/mol, about 400,000 to about 500,000 g/mol, or about 450,000 to about 500,000 g/mol. In some aspects, the HASE polymer has a molecular weight of about 50,000 g/mol, about 80,000 g/mol, about 100,000 g/mol, about 150,000 g/mol, about 200,000 g/mol, about 250,000 g/mol, about 300,000 g/mol, about 350,000 g/mol, about 400,000 g/mol, about 450,000 g/mol, or about 500,000 g/mol.

In some aspects, the ratio of x:y is between 1:20 to 20:1, between 1:10 to 10:1, or between 1:5 to 5:1. In some aspects, the ratio of x:w is between 1:20 to 20:1, between 1:10 to 10:1, or between 1:5 to 5:1. In some aspects, the ratio of x:z can be between 1:1 to 500:1, between 2:1 to 250:1, or between 25:1 to 75:1.

Methods of making such HASE polymer are described in U.S. Pat. Nos. 4,514,552, 5,192,592, and 7,217,443 and British Patent No. 870,994, each of which is incorporated herein by reference.

In some aspects, the rheology modifier is an ASE polymer. In some aspects, the ASE polymer has the following structure:

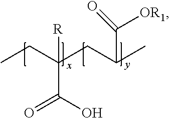

wherein R is H or C₁₋₂₀ alkyl, R₁ is C₁₋₂₀ alkyl, and x and y are integers.

In some aspects, the ratio of x:y is about 1:20 to about 20:1, about 1:10 to 10:1, or about 1:5 to 5:1. In some aspects, the ratio of x:w is about 1:20 to about 20:1, about 1:10 to about 10:1, or about 1:5 to about 5:1. In some aspects, the ratio of x:z is between 1:1 to about 500:1, about 2:1 to about 250:1, or about 25:1 to about 75:1.

In some aspects, the ASE polymer has a molecular weight of about 50,000 to about 500,000 g/mol, about 80,000 to about 400,000 g/mol, about 100,000 to about 300,000 g/mol, about 50,000 to about 450,000 g/mol, about 50,000 to about 400,000 g/mol, about 50,000 to about 350,000 g/mol, about 50,000 to about 300,000 g/mol, about 50,000 to about 250,000 g/mol, about 50,000 to about 200,000 g/mol, about 50,000 to about 150,000 g/mol, about 50,000 to about 100,000 g/mol, about 100,000 to about 500,000 g/mol, about 150,000 to about 500,000 g/mol, about 200,000 to about 500,000 g/mol, about 250,000 to about 500,000 g/mol, about 300,000 to about 500,000 g/mol, about 350,000 to about 500,000 g/mol, about 400,000 to about 500,000 g/mol, or about 450,000 to about 500,000 g/mol. In some aspects, the ASE polymer has a molecular weight of about 50,000 g/mol, about 80,000 g/mol, about 100,000 g/mol, about 150,000 g/mol, about 200,000 g/mol, about 250,000 g/mol, about 300,000 g/mol, about 350,000 g/mol, about 400,000 g/mol, about 450,000 g/mol, or about 500,000 g/mol.

In some aspects, the liquid composition comprises a total from about 0.1 wt % to about 5 wt % of a rheology modifier relative to the total weight of the liquid composition. For example, the total rheology modifier content can be from about 0.1 wt % to about 4 wt %, about 0.1 wt % to about 3 wt %, about 0.1 wt % to about 2 wt %, about 0.1 wt % to about 1 wt %, about 0.5 wt % to about 5 wt %, 0.5 wt % to about 4 wt %, about 0.5 wt % to about 3 wt %, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 1.5 wt % to about 5 wt %, about 1.5 wt % to about 4 wt %, about 1.5 wt % to about 3 wt %, about 1.5 wt % to about 2 wt %, about 2 wt % to about 5 wt %, about 2 wt % to about 4 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the liquid composition.

In some aspects, the liquid composition comprises an anti-redeposition agent that keeps dissolved soil stains stable in the wash water and prevent the stains from redepositing on a textile. In some aspects, the anti-redeposition polymer is biodegradable. In some aspects, the anti-redeposition polymer can be based on acrylic acid, e.g., a homopolymer of acrylic acid, a polycarboxylate based on acrylic acid, a copolymer of acrylic acid and polystyrene, or a copolymer of maleic acid and acrylic acid. Examples of a suitable anti-redeposition polymer include, e.g., sodium polyacrylate, modified polyethylene glycol, styrene-acrylic acid copolymer, polyethyleneimine, or a combination thereof. In some aspects, the anti-redeposition polymer comprises sodium polyacrylate.

In some aspects, the liquid composition comprises from about 0.001 wt % to about 5 wt % of an anti-redeposition polymer relative to the total weight of the liquid composition. For example, the anti-redeposition polymer can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the liquid composition.

In some aspects, the liquid composition comprises a chelating agent (i.e., a chelant) that serves to improve the cleaning action of the detergent by scavenging metal ions naturally found in water. Suitable examples of a chelating agent include, e.g., citric acid, oxalic acid, nitriloacetic acid, phosphoric acid, polyphosphoric acid (e.g., a polyphosphate, such as tripolyphosphate), a phosphonate, ethylenediaminetetraacetic acid, diethylenetriaminepentaacetic acid (pentetic acid), hydroxyethylethylenediaminetriacetic acid, glutamic acid, aspartic acid, iminodisuccinic acid, any salt thereof (e.g., sodium citrate, disodium edetate, tetrasodium glutamate diacetate, tetrasodium aspartate diacetate, tetrasodium iminodisuccinate), or any combination thereof. In some aspects, the liquid composition comprises iminodisuccinic acid and/or tetrasodium iminodisuccinate.

In some aspects, the liquid composition comprises from about 0.001 wt % to about 5 wt % of a chelating agent relative to the total weight of the liquid composition. For example, the chelating agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the liquid composition.

In some aspects, the liquid composition comprises a fragrance as an additive, including a fragrance oil or an encapsulated fragrance.

A fragrance oil is any suitable scented oil generally regarded as safe (GRAS) at the levels used in the liquid composition. Suitable fragrance oils can be natural or synthetic. Examples of natural oils incluse those extracted from a plant, flower, or fruit (e.g., basil oil, bay oil, bergamot oil, cinnamon oil, clove oil, lavender oil, eucalyptus oil, lavender oil, ginger oil, geranium oil, rose oil, blue tansy oil, tea tree oil, moringa oil, lemon balm essential oil, lemongrass oil, thyme oil, rosemary oil, mint oil, lemon oil, orange oil, and grapefruit oil). In some aspects, the fragrance oil comprises a carrier oil, such as vegetable oil, vegetable shortening, castor oil, rice brain oil, olive oil, canola oil, corn oil, palm oil, coconut oil, flaxseed oil, hempseed oil, rapeseed oil, linseed oil, grapeseed oil, rosehip seed oil, pomegranate seed oil, watermelon seed oil, seabuckthorn berry oil, camellia seed oil (tea oil), cranberry seed oil, hemp seed oil, borage seed oil, evening primrose oil, argan oil, jojoba oil, marula oil, carrot oil, sesame seed oil, sunflower oil, shea nut oil, soybean oil, peanut oil, walnut oil, almond oil, hazelnut oil, kukui nut oil, pecan oil, macadamia nut oil, meadowfoam oil, avocado oil, apricot kernel oil, an essential oil, silicone oil, fish oil, cocoa butter, shea butter, butter, ghee, medium chain triglycercides (MCT), or any combination thereof.

Encapsulated fragrance typically comprises a fragrance oil, as described herein, enclosed within a polymer shell that imparts long-lasting freshness and odor control to washed laundry. Within a wash load, the fragrance oil disperses from the shell, typically through diffusion or rupturing or dissolution of the shell, thereby allowing the fragrance oil to infuse into the textiles being washed. Rupturing the shell can be mechanical, based on temperature, or both.

In some aspects, the shell is a hollow capsule formed from one or more polymers and that acts as a coating for the fragrance oil. In some aspects, the shell is not hollow but allows for the fragrance oil to be dispersed within the polymer matrix. The polymer can be natural or synthetic. In some aspects, the polymer is a water soluble polymer. In some aspects, the one or more polymers can be, for example, a melamine formaldehyde, a polyamide, a polystyrene, a polyisoprene, a polycarbonate, a polyester, a polyurea, a polyurethane, a polyureaurethane, a polyolefin, a polyacrylate, a vinyl polymer, a polysaccharide (e.g., cyclodextrin, chitosan, carrageenan), a gum (e.g., guar gum (acacia), gum Arabic, gellan gum, gum tragacanth), an epoxy resin, gelatin, shellac, silicone, silk, wool, gelatine, a cellulose (e.g., carboyxmethyl cellulose, hydroxymethylcellulose, hydroxyethylcellulose, hydroxypropylcellulose, hydroxypropyl methylcellulose, microcrystalline cellulose), a protein (e.g., zein), or any combination thereof. Combinations of polymers includes, for example, polyethylene glycol/polycaprolactone, polyethylene glycol/polyvinyl acetate, polyurethane/β-cyclodextrin, silk fibroin/β-cyclodextrin, cellulose derivatives/polyvinyl alcohol, gelatin/acacia, and polyvinyl alcohol/gum Arabic/β-cyclodextrin. In some aspects, the polymer shell comprises a melamine formaldehyde. The shell can be any suitable size and typically is on a micron scale (e.g., about 3 to about 25 μm).

Examples of encapsulated fragrances are described in, for example, U.S. Pat. Nos. 6,024,943, 6,056,949, 6,194,375, 6,458,754, 8,426,353, and 10,047,324, and U.S. Patent Application Publication 2011/0224127, each of which is incorporated by reference in its entirety.

The encapsulated fragrance can be used in solid, dry form (i.e., without solvent) or as a slurry (i.e., dispersed in one or more solvents). In some aspects, the encapsulated fragrance is a slurry comprising one or more solvents. Suitable solvents include, for example, water, a glycol (e.g., glycerin, propylene glycol, dipropylene glycol), an alcohol (e.g., ethanol, phenoxyethanol), an ethoxylated fatty alcohol (e.g., ethoxylated C₁₂₋₁₅ alcohol), or any combination thereof. In some aspects, the encapsulated fragrance contains about 40-80% water. In some aspects, the encapsulated fragrance includes one or more solid carriers, such as a zeolite (e.g., faujasite, mordonite), silica, or gum tragacanth. When one or more solvents are used, the solids content of the slurry can vary. In some aspects, the solids content is about 50% in the slurry.

In some aspects, the liquid composition comprises from about 10 wt % to about 35 wt % of fragrance (e.g., encapsulated fragrance) relative to the total weight of the liquid composition. For example, the total fragrance content can be present in an amount from about 10 wt % to about 32 wt %, about 10 wt % to about 30 wt %, about 10 wt % to about 28 wt %, about 10 wt % to about 25 wt %, about 10 wt % to about 32 wt %, about 10 wt % to about 30 wt %, about 10 wt % to about 28 wt %, about 10 wt % to about 25 wt %, about 12 wt % to about 35 wt %, about 12 wt % to about 32 wt %, about 12 wt % to about 30 wt %, about 12 wt % to about 28 wt %, about 12 wt % to about 25 wt %, about 15 wt % to about 35 wt %, about 15 wt % to about 32 wt %, about 15 wt % to about 30 wt %, about 15 wt % to about 28 wt %, about 15 wt % to about 25 wt %, about 18 wt % to about 35 wt %, about 18 wt % to about 32 wt %, about 18 wt % to about 30 wt %, about 18 wt % to about 28 wt %, about 18 wt % to about 25 wt %, about 20 wt % to about 35 wt %, about 20 wt % to about 32 wt %, about 20 wt % to about 30 wt %, about 20 wt % to about 28 wt %, about 20 wt % to about 25 wt %, about 22 wt % to about 35 wt %, about 22 wt % to about 32 wt %, about 22 wt % to about 30 wt %, about 22 wt % to about 28 wt %, about 22 wt % to about 25 wt %, about 25 wt % to about 35 wt %, about 25 wt % to about 32 wt %, about 25 wt % to about 30 wt %, about 25 wt % to about 28 wt %, about 35 wt %, about 32 wt %, about 30 wt %, about 28 wt %, about 25 wt %, about 22 wt %, about 20 wt %, about 18 wt %, about 15 wt %, about 12 wt %, or about 10 wt % of the total weight of the liquid composition. In some aspects, the liquid composition comprises from about 20 wt % to about 30 wt % of encapsulated fragrance relative to the total weight of the liquid composition.

In some aspects, the liquid composition comprises a bitterant as an additive. A bitterant (e.g., a bittering agent) can be any suitable compound that imparts a bitter taste to the composition. The bitterant can be added to avoid accidental poisoning. Examples of the bitterant include, e.g., denatonium benzoate, sucrose octaacetate, quercetin, brucine, quassin, and combinations thereof. In an aspect, the bitterant is denatonium benzoate.

In some aspects, the liquid composition can comprise from about 0.001 wt % to about 2 wt % of a bitterant relative to the total weight of the liquid composition. For example, the bitterant can be present in an amount about 0.001 wt % to about 1.8 wt %, about 0.001 wt % to about 1.5 wt %, about 0.001 wt % to about 1.2 wt %, about 0.001 wt % to about 1 wt %, about 0.001 wt % to about 0.9 wt %, about 0.001 wt % to about 0.8 wt %, about 0.001 wt % to about 0.7 wt %, about 0.001 wt % to about 0.5 wt %, about 0.005 wt % to about 2 wt %, about 0.005 wt % to about 1.8 wt %, about 0.005 wt % to about 1.5 wt %, about 0.005 wt % to about 1.2 wt %, about 0.005 wt % to about 1 wt %, about 0.005 wt % to about 0.9 wt %, about 0.005 wt % to about 0.8 wt %, about 0.005 wt % to about 0.6 wt %, about 0.005 wt % to about 0.5 wt %, about 0.01 wt % to about 2 wt %, about 0.01 wt % to about 1.8 wt %, about 0.01 wt % to about 1.5 wt %, about 0.01 wt % to about 1.2 wt %, about 0.01 wt % to about 1 wt %, about 0.01 wt % to about 0.9 wt %, about 0.01 wt % to about 0.8 wt %, about 0.01 wt % to about 0.5 wt %, about 0.05 wt % to about 2 wt %, about 0.05 wt % to about 1.8 wt %, about 0.05 wt % to about 1.5 wt %, about 0.05 wt % to about 1.2 wt %, about 0.05 wt % to about 1 wt %, about 0.05 wt % to about 0.9 wt %, about 0.05 wt % to about 0.8 wt %, about 0.05 wt % to about 0.5 wt %, about 0.05 wt % to about 0.1 wt %, about 0.1 wt % to about 2 wt %, about 0.1 wt % to about 1.8 wt %, about 0.1 wt % to about 1.5 wt %, about 0.1 wt % to about 1.2 wt %, about 0.1 wt % to about 1 wt %, about 0.1 wt % to about 0.8 wt %, about 0.1 wt % to about 0.6 wt %, about 0.1 wt % to about 0.5 wt %, about 0.1 wt % to about 0.2 wt %, about 0.2 wt % to about 2 wt %, about 0.2 wt % to about 1.8 wt %, about 0.2 wt % to about 1.5 wt %, about 0.2 wt % to about 1.2 wt %, about 0.2 wt % to about 1 wt %, about 0.2 wt % to about 0.8 wt %, about 0.2 wt % to about 0.6 wt %, about 0.2 wt % to about 0.5 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2 wt % of the total weight of the liquid composition. In some aspects, the liquid composition can comprise from 0.01 wt % to about 0.2 wt % of a bitterant relative to the total weight of the liquid composition.

In some aspects, the liquid composition has a pH of about 7.5 to about 11 (e.g., about 7.5 to about 10.5, about 7.5 to about 10, about 7.5 to about 9, about 7.5 to about 8.5, or about 7.5 to about 8, about 8 to about 11, about 8 to about 10.5, about 8 to about 10, about 8 to about 9.5, about 8 to about 9, about 8 to about 8.5, about 8.5 to about 11, about 8.5 to about 10.5, about 8.5 to about 10, about 8.5 to about 9.5, about 8.5 to about 9, about 9 to about 11, about 9 to about 10.5, about 9 to about 10, about 9 to about 9.5, about 9.5 to about 11, about 9.5 to about 10.5, about 9.5 to about 10, about 10 to about 11, about 10 to about 10.5, or about 10.5 to about 11). In some aspects, the liquid composition has a pH of about 7.5, about 7.6, about 7.7, about 7.8, about 7.9, about 8, about 8.1, about 8.2, about 8.3, about 8.4, about 8.5, about 8.6, about 8.7, about 8.8, about 8.9, about 9, about 9.1, about 9.2, about 9.3, about 9.4, about 9.5, about 9.6, about 9.7, about 9.8, about 9.9, about 10, about 10.1, about 10.2, about 10.3, about 10.4, about 10.5, about 10.6, about 10.7, about 10.8, about 10.9, or about 11.

In some aspects, the liquid composition can comprise a pH-adjusting agent as an additive. The pH-adjusting agent can be an acid, a base, or both an acid and a base. In some aspects, the liquid composition comprises a base as a pH-adjusting agent. In some aspects, a base is present to neutralize a rheology modifier.

The base can be any suitable compound with a pKb of about 1 to about 13. The base can be any suitable compound with a pKb of about 1 to about 13. In some aspects, the base can be monoethanolamine, diethanolamine, triethanolamine, methyl diethanolamine, a hydroxide, a tetraborate, a phosphate, a carbonate, a bicarbonate, or a combination thereof. The base can include a counterion, such as a Group I cation or Group II cation. In some aspects, the base is a Group I hydroxide, a Group II hydroxide, sodium tetraborate, trisodium phosphate, sodium carbonate, or a combination thereof. In some aspects, the base can be a monoethanolamine, sodium carbonate, or a Group I hydroxide (e.g., sodium hydroxide, potassium hydroxide, or a combination of both). In some aspects, the liquid composition comprises monoethanolamine.

The acid can be any suitable compound with a pKa of less than about 10. In some aspects, the acid is an inorganic acid or an organic acid. Examples of an inorganic acid include hydrochloric acid, nitric acid, nitrous acid, sulfuric acid, sulfurous acid, phosphoric acid, boric acid, hydrobromic acid, hydroiodic acid, perchloric acid, and combinations thereof. In some aspects, the acid is a weak acid such that the acid has a pKa of 2 or greater (e.g., pKa is about 2 to about 10). Examples of a weak acid include, e.g., an organic acid or carbonic acid, hydrocyanic acid, phosphoric acid, sulfurous acid, nitrous acid, or a combination thereof.

An organic acid can contain one or more (e.g., 1, 2, or 3) carboxylic acid groups, which can be used singly or in combination. For example, monocarboxylic acids include formic acid, acetic acid, propionic acid, butanoic acid, quinic acid, shikimic acid, lactic acid, sorbic acid, caproic acid, capyrylic acid, capric acid, lauric acid, and stearic acid. Di- and tricarboxylic acids include citric acid, isocitric acid, cis-aconitic acid, adipic acid, gluconic acid, glutaric acid, itaconic acid, ascorbic acid, succinic acid, malonic acid, malic acid, maleic acid, fumaric acid, tartaric acid, and oxalic acid.

In some aspects, the liquid composition comprises from about 0.1 wt % to about 5 wt % of a pH adjusting agent (e.g., a base) relative to the total weight of the liquid composition. For example, the total pH adjusting agent content can be from about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 0.8 wt % to about 5 wt %, about 0.8 wt % to about 3 wt %, about 0.8 wt % to about 2 wt %, about 0.8 wt % to about 1 wt %, about 1 wt % to about 5 wt %, about 1 wt % to about 4 wt %, about 1 wt % to about 3 wt %, about 1 wt % to about 2 wt %, about 1.5 wt % to about 5 wt %, about 1.5 wt % to about 4 wt %, about 1.5 wt % to about 3 wt %, about 1.5 wt % to about 2 wt %, about 2 wt % to about 5 wt %, about 2 wt % to about 4 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the liquid composition. In some aspects, the liquid composition comprises from about 0.4 wt % to about 1.5 wt % of a pH adjusting agent.

The second compartment is adjacent to the first compartment and encloses a powder composition. The powder composition comprises a pigment and at least one additive selected from a salt, a flow aid, acid, enzyme, chelating agent, a polymer, and any combination thereof.

The pigment is any suitable colorant that is generally regarded as safe (GRAS). Any desired color, such as red, blue, yellow, purple, pink, or green, can be used. The pigment can be organic or inorganic but typically is inorganic. Unlike a dye, a pigment is not water soluble. In some aspects, the pigment contains at least one metal, i.e., a metallic pigment. In some aspects, the pigment comprises at least one metal selected from the group consisting of aluminum, barium, cadmium, chromium, cobalt, copper, iron oxide, manganese, mercury, titanium, zinc, and any combination thereof. In some aspects, the pigment is plant-based. Suitable examples of pigment include, for example, a carotenoid, a phthalocyanine, a chlorophyll, an anthocyanin, a betalain, vermilion, ultramarine blue, ochre, Prussian blue, sienna, umber, carmine, and any combination thereof.

In some aspects, the powder composition does not contain (i.e., is substantially free of) a dye, such as a water soluble dye.

In some aspects, the powder composition comprises from about 0.001 wt % to about 3 wt % of a pigment relative to the total weight of the powder composition. For example, the pigment can be present in an amount from about 0.001 wt % to about 2.8 wt %, about 0.001 wt % to about 2.5 wt %, about 0.001 wt % to about 2.2 wt %, about 0.001 wt % to about 2 wt %, about 0.001 wt % to about 1.8 wt %, about 0.001 wt % to about 1.5 wt %, about 0.001 wt % to about 1.2 wt %, about 0.001 wt % to about 1 wt %, about 0.001 wt % to about 0.9 wt %, about 0.001 wt % to about 0.8 wt %, about 0.001 wt % to about 0.7 wt %, about 0.001 wt % to about 0.5 wt %, about 0.005 wt % to about 3 wt %, about 0.005 wt % to about 2.8 wt %, about 0.005 wt % to about 2.5 wt %, about 0.005 wt % to about 2.2 wt %, about 0.005 wt % to about 2 wt %, about 0.005 wt % to about 1.8 wt %, about 0.005 wt % to about 1.5 wt %, about 0.005 wt % to about 1.2 wt %, about 0.005 wt % to about 1 wt %, about 0.005 wt % to about 0.9 wt %, about 0.005 wt % to about 0.8 wt %, about 0.005 wt % to about 0.6 wt %, about 0.005 wt % to about 0.5 wt %, about 0.01 wt % to about 3 wt %, about 0.01 wt % to about 2.8 wt %, about 0.01 wt % to about 2.5 wt %, about 0.01 wt % to about 2.2 wt %, about 0.01 wt % to about 2 wt %, about 0.01 wt % to about 1.8 wt %, about 0.01 wt % to about 1.5 wt %, about 0.01 wt % to about 1.2 wt %, about 0.01 wt % to about 1 wt %, about 0.01 wt % to about 0.9 wt %, about 0.01 wt % to about 0.8 wt %, about 0.01 wt % to about 0.5 wt %, about 0.05 wt % to about 3 wt %, about 0.05 wt % to about 2.8 wt %, about 0.05 wt % to about 2.5 wt %, about 0.05 wt % to about 2.2 wt %, about 0.05 wt % to about 2 wt %, about 0.05 wt % to about 1.8 wt %, about 0.05 wt % to about 1.5 wt %, about 0.05 wt % to about 1.2 wt %, about 0.05 wt % to about 1 wt %, about 0.05 wt % to about 0.9 wt %, about 0.05 wt % to about 0.8 wt %, about 0.05 wt % to about 0.5 wt %, about 0.05 wt % to about 0.1 wt %, about 0.1 wt % to about 3 wt %, about 0.1 wt % to about 2.8 wt %, about 0.1 wt % to about 2.5 wt %, about 0.1 wt % to about 2.2 wt %, about 0.1 wt % to about 2 wt %, about 0.1 wt % to about 1.8 wt %, about 0.1 wt % to about 1.5 wt %, about 0.1 wt % to about 1.2 wt %, about 0.1 wt % to about 1 wt %, about 0.1 wt % to about 0.8 wt %, about 0.1 wt % to about 0.6 wt %, about 0.1 wt % to about 0.5 wt %, about 0.1 wt % to about 0.2 wt %, about 0.2 wt % to about 3 wt %, about 0.2 wt % to about 2.8 wt %, about 0.2 wt % to about 2.5 wt %, about 0.2 wt % to about 2.2 wt %, about 0.2 wt % to about 2 wt %, about 0.2 wt % to about 1.8 wt %, about 0.2 wt % to about 1.5 wt %, about 0.2 wt % to about 1.2 wt %, about 0.2 wt % to about 1 wt %, about 0.2 wt % to about 0.8 wt %, about 0.2 wt % to about 0.6 wt %, about 0.2 wt % to about 0.5 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, or about 3 wt % of the total weight of the powder composition.

In some aspects, the powder composition comprises pigment in an amount from about 0.05 wt % to about 1.5 wt % or about 0.1 wt % to about 1 wt %. It has been discovered that in the above preferred ranges, the colors can generally be successfully imparted to the powder while at the same time does not cause fabric stain across different choices of pigments.

The powder composition comprises at least one (e.g., 1, 2, 3, 4, 5, or 6, etc.) additive selected from a salt, a flow aid, acid, enzyme, chelating agent, a polymer, and any combination thereof in addition to the pigment.

In some aspects, the powder composition comprises a salt as an inert processing aid. The salt is any suitable salt, such as a chloride, a bromide, an iodide, a fluoride, a nitrate, a nitrite, a sulfate, a sulfite, a sulfide, a phosphate, a phosphide, a carbonate, a bicarbonate, or any combination thereof. The salt can be counterbalanced by any suitable counterion, such as a Group I (e.g., lithium, sodium, potassium), Group II (e.g., magnesium, calcium, barium), or ammonium cation. In some aspects, the counterion is a sodium cation, a potassium cation, or a combination of both. In some aspects, the powder composition comprises a chloride (e.g., sodium chloride), a carbonate (e.g., sodium carbonate), a sulfate (e.g., sodium sulfte), or any combination thereof.

In some aspects, the powder composition comprises from about 60 wt % to about 99.9 wt % of the salt relative to the total weight of the powder composition. For example, the salt can be present in an amount from about 60 wt % to about 99.5 wt %, about 60 wt % to about 99 wt %, about 60 wt % to about 98 wt %, about 60 wt % to about 97 wt %, about 60 wt % to about 96 wt %, about 60 wt % to about 95 wt %, about 60 wt % to about 94 wt %, about 60 wt % to about 93 wt %, about 60 wt % to about 90 wt %, about 60 wt % to about 85 wt %, about 60 wt % to about 80 wt %, about 60 wt % to about 75 wt %, about 60 wt % to about 70 wt %, about 65 wt % to about 99.9 wt %, about 65 wt % to about 99.5 wt %, about 65 wt % to about 99 wt %, about 65 wt % to about 98 wt %, about 65 wt % to about 97 wt %, about 65 wt % to about 96 wt %, about 65 wt % to about 95 wt %, about 65 wt % to about 94 wt %, about 65 wt % to about 93 wt %, about 65 wt % to about 90 wt %, about 65 wt % to about 85 wt %, about 65 wt % to about 80 wt %, about 65 wt % to about 75 wt %, about 65 wt % to about 70 wt %, about 70 wt % to about 99.9 wt %, about 70 wt % to about 99.5 wt %, about 70 wt % to about 99 wt %, about 70 wt % to about 98 wt %, about 70 wt % to about 97 wt %, about 70 wt % to about 96 wt %, about 70 wt % to about 95 wt %, about 70 wt % to about 94 wt %, about 70 wt % to about 93 wt %, about 70 wt % to about 90 wt %, about 70 wt % to about 85 wt %, about 70 wt % to about 80 wt %, about 70 wt % to about 75 wt %, about 80 wt % to about 99.5 wt %, about 80 wt % to about 99 wt %, about 80 wt % to about 98 wt %, about 80 wt % to about 97 wt %, about 80 wt % to about 96 wt %, about 80 wt % to about 95 wt %, about 80 wt % to about 94 wt %, about 80 wt % to about 93 wt %, about 80 wt % to about 92 wt %, about 80 wt % to about 91 wt %, about 80 wt % to about 90 wt %, about 85 wt % to about 99.9 wt %, about 85 wt % to about 99.5 wt %, about 85 wt % to about 99 wt %, about 85 wt % to about 98 wt %, about 85 wt % to about 97 wt %, about 85 wt % to about 96 wt %, about 85 wt % to about 95 wt %, about 85 wt % to about 94 wt %, about 85 wt % to about 93 wt %, about 85 wt % to about 92 wt %, about 85 wt % to about 91 wt %, about 85 wt % to about 90 wt %, about 90 wt % to about 99.9 wt %, about 90 wt % to about 99.5 wt %, about 90 wt % to about 99 wt %, about 90 wt % to about 98 wt %, about 90 wt % to about 97 wt %, about 90 wt % to about 96 wt %, about 90 wt % to about 95 wt %, about 90 wt % to about 94 wt %, about 90 wt % to about 93 wt %, about 90 wt % to about 93 wt %, about 90 wt % to about 92 wt %, about 90 wt % to about 91 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, about 99.5 wt %, or about 99.9 wt % of the total weight of the powder composition.

In some aspects, the powder composition comprises a flow aid to keep the powder composition from caking or lumping. In an aspect, a suitable flow aid includes an inert solid that can absorb water. Examples of flow aids include, for example, silica, calcium oxide, a silicate (e.g., sodium silicate, sodium aluminosilicate, aluminium calcium silicate, calcium silicate, magnesium silicate,), an aluminate, a citrate, a carbonate, a bicarbonate, a phosphate (e.g., sodium orthophosphate), a stearate (e.g., magnesium stearate), a clay, flour, fly ash, starch, a zeolite, or a combination thereof. In general, a zeolite is a hydrate aluminosilicate of the alkaline and alkaline earth methods and can be natural or synthetic. Suitable clays include, any natural clay, such as bentonite clay, kaolin clay, rose clay, a Brazilian clay, a French clay (e.g., French green clay, French red clay, French pink clay, or French yellow clay), Cambrian blue clay, Green zeolite clay, sea clay, and any combination thereof. Suitable zeolites include, for example, analcime, chabazite, clinoptilolite, erionite, ferrierite, heulandite, laumontite, mordenite, stilbite, phillipsite, zeolite A type (Linde Type A, including homologs, such as Li-LTA, K-LTA, and Ca-LTA), faujasite (FAU-type zeolite, including zeolite X and zeolite Y), ZMS-5, and any combination thereof. Flow aids in the form of salts can include one or more suitable counterions, such as a Group I, Group II, or ammonium cation. In an aspect, the powder composition comprises a zeolite as a flow aid.

In some aspects, the powder composition comprises from about 0.05 wt % to about 10 wt % of a flow aid relative to the total weight of the powder composition. For example, the flow aid can be present in an amount from about 0.05 wt % to about 8 wt %, about 0.05 wt % to about 5 wt %, 0.05 wt % to about 4 wt %, about 0.05 wt % to about 3 wt %, about 0.05 wt % to about 2 wt %, about 0.05 wt % to about 1.5 wt %, about 0.05 wt % to about 1.2 wt %, about 0.05 wt % to about 1 wt %, about 0.05 wt % to about 0.8 wt %, about 0.1 wt % to about 10 wt %, about 0.1 wt % to about 8 wt %, about 0.1 wt % to about 5 wt %, 0.1 wt % to about 4 wt %, about 0.1 wt % to about 3 wt %, about 0.1 wt % to about 2 wt %, about 0.1 wt % to about 1.8 wt %, about 0.1 wt % to about 1.5 wt %, about 0.1 wt % to about 1.2 wt %, about 0.5 wt % to about 10 wt %, about 0.5 wt % to about 8 wt %, about 0.5 wt % to about 5 wt %, 0.5 wt % to about 4 wt %, about 0.5 wt % to about 3 wt %, about 0.5 wt % to about 2 wt %, about 0.5 wt % to about 1.5 wt, about 0.5 wt % to about 1 wt %, about 0.5 wt % to about 0.8 wt %, about 1 wt % to about 10 wt %, about 1 wt % to about 8 wt %, about 1 wt % to about 5 wt %, about 1 wt % to about 4 wt %, about 1 wt % to about 3 wt %, about 1 wt % to about 2 wt %, about 1 wt % to about 1.8 wt %, about 1 wt % to about 1.5 wt %, about 1 wt % to about 1.2 wt %, about 1.5. wt % to about 10 wt %, about 1.5 wt % to about 8 wt %, about 1.5 wt % to about 5 wt %, about 1.5 wt % to about 4 wt %, about 1.5 wt % to about 3 wt %, about 1.5 wt % to about 2 wt %, about 1.5 wt % to about 1.8 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the powder composition.

In some aspects, the powder composition comprises an acid. The acid can be any suitable compound with a pKa of less than about 10. In some aspects, the acid is an inorganic acid or an organic acid. In some aspects, the acid is anhydrous. Examples of an inorganic acid include hydrochloric acid, nitric acid, nitrous acid, sulfuric acid, sulfurous acid, phosphoric acid, boric acid, hydrobromic acid, hydroiodic acid, perchloric acid, and combinations thereof. In some aspects, the acid is a weak acid such that the acid has a pKa of 2 or greater (e.g., pKa is about 2 to about 10). Examples of a weak acid include, e.g., an organic acid or carbonic acid, hydrocyanic acid, phosphoric acid, sulfurous acid, nitrous acid, or any combination thereof.

An organic acid (e.g., an anhydrous organic acid) can contain one or more (e.g., 1, 2, or 3) carboxylic acid groups, which can be used singly or in combination. For example, monocarboxylic acids include formic acid, acetic acid, propionic acid, butanoic acid, quinic acid, shikimic acid, lactic acid, sorbic acid, caproic acid, capyrylic acid, capric acid, lauric acid, and stearic acid. Di- and tricarboxylic acids include citric acid, isocitric acid, cis-aconitic acid, adipic acid, gluconic acid, glutaric acid, itaconic acid, ascorbic acid, succinic acid, malonic acid, malic acid, maleic acid, fumaric acid, tartaric acid, and oxalic acid. In some aspects, the acid is citric acid, such as anhydrous citric acid.

In some aspects, the powder composition comprises from about 0.1 wt % to about 5 wt % of an acid relative to the total weight of the powder composition. For example, the total acid content can be from about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 0.8 wt % to about 5 wt %, about 0.8 wt % to about 3 wt %, about 0.8 wt % to about 2 wt %, about 0.8 wt % to about 1 wt %, about 1 wt % to about 5 wt %, about 1 wt % to about 4 wt %, about 1 wt % to about 3 wt %, about 1 wt % to about 2 wt %, about 1.5 wt % to about 5 wt %, about 1.5 wt % to about 4 wt %, about 1.5 wt % to about 3 wt %, about 1.5 wt % to about 2 wt %, about 2 wt % to about 5 wt %, about 2 wt % to about 4 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the liquid composition.

In some aspects, the powder composition comprises an enzyme to aid in removing stains, including protein stains, oil stains, tannin stains, starch stains, and dyes. For example, a protease is capable of breaking down protein-based stains, such as sweat, blood, mud, and dairy products. An amylase is capable of breaking down a starch-based stain, such as cornstarch or potato starch. A lipase is capable of breaking down fats. A mannanase is capable of breaking down guar and locust bean stains. In some aspects, the at least one enzyme is a hydrolytic enzyme. The at least one enzyme can comprise a protease, an amylase, a mannanase, a lactase, a lipase, a perhydrolase, an oxidoreductase, an endocellulase, an exocellulase, or a combination thereof. In some aspects, the powder composition comprises a protease, an amylase, a mannanase, or a combination thereof.

In some aspects, the powder composition comprises a total from about 0.1 wt % to about 8 wt % of at least one enzyme (e.g., a protease, an amylase, a mannanase, or a combination thereof) relative to the total weight of the powder composition. For example, the total enzyme content can be from about 0.1 wt % to about 5 wt %, about 0.1 wt % to about 3 wt %, about 0.1 wt % to about 2 wt %, about 0.1 wt % to about 1 wt %, about 0.5 wt % to about 8 wt %, about 0.5 wt % to about 5 wt %, about 0.5 wt % to about 3 wt %, about 0.5 wt % to about 2 wt %, about 0.5 wt % to about 1 wt %, about 1 wt % to about 8 wt %, about 1 wt % to about 5 wt %, about 1 wt % to about 4 wt %, about 1 wt % to about 3 wt %, about 1 wt % to about 2 wt %, about 2 wt % to about 8 wt %, about 2 wt % to about 6 wt %, about 2 wt % to about 5 wt %, about 2 wt % to about 4 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, about 5 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, or about 8 wt % of the total weight of the powder composition.

In some aspects, the powder composition comprises a chelating agent (i.e., a chelant) that serves to improve the cleaning action of the detergent by scavenging metal ions naturally found in water. In an aspect, the chelating agent is a solid in the powder composition. Suitable examples of a chelating agent include, e.g., citric acid (e.g., anhydrous citric acid), oxalic acid, nitriloacetic acid, phosphoric acid, polyphosphoric acid (e.g., a polyphosphate, such as tripolyphosphate), a phosphonate, ethylenediaminetetraacetic acid, diethylenetriaminepentaacetic acid (pentetic acid), hydroxyethylethylenediaminetriacetic acid, glutamic acid, aspartic acid, iminodisuccinic acid, any salt thereof (e.g., sodium citrate, disodium edetate, tetrasodium glutamate diacetate, tetrasodium aspartate diacetate, tetrasodium iminodisuccinate), or any combination thereof. In some aspects, the powder composition comprises citric acid, such as anhydrous citric acid, and/or a salt of diethylenetriaminepentaacetic acid (e.g., pentasodium pentetate).

In some aspects, the powder composition comprises from about 60 wt % to about 99.9 wt % of the chelating agent relative to the total weight of the powder composition. For example, the chelating agent can be present in an amount from about 60 wt % to about 99.5 wt %, about 60 wt % to about 99 wt %, about 60 wt % to about 98 wt %, about 60 wt % to about 97 wt %, about 60 wt % to about 96 wt %, about 60 wt % to about 95 wt %, about 60 wt % to about 94 wt %, about 60 wt % to about 93 wt %, about 60 wt % to about 90 wt %, about 60 wt % to about 85 wt %, about 60 wt % to about 80 wt %, about 60 wt % to about 75 wt %, about 60 wt % to about 70 wt %, about 65 wt % to about 99.9 wt %, about 65 wt % to about 99.5 wt %, about 65 wt % to about 99 wt %, about 65 wt % to about 98 wt %, about 65 wt % to about 97 wt %, about 65 wt % to about 96 wt %, about 65 wt % to about 95 wt %, about 65 wt % to about 94 wt %, about 65 wt % to about 93 wt %, about 65 wt % to about 90 wt %, about 65 wt % to about 85 wt %, about 65 wt % to about 80 wt %, about 65 wt % to about 75 wt %, about 65 wt % to about 70 wt %, about 70 wt % to about 99.9 wt %, about 70 wt % to about 99.5 wt %, about 70 wt % to about 99 wt %, about 70 wt % to about 98 wt %, about 70 wt % to about 97 wt %, about 70 wt % to about 96 wt %, about 70 wt % to about 95 wt %, about 70 wt % to about 94 wt %, about 70 wt % to about 93 wt %, about 70 wt % to about 90 wt %, about 70 wt % to about 85 wt %, about 70 wt % to about 80 wt %, about 70 wt % to about 75 wt %, about 80 wt % to about 99.5 wt %, about 80 wt % to about 99 wt %, about 80 wt % to about 98 wt %, about 80 wt % to about 97 wt %, about 80 wt % to about 96 wt %, about 80 wt % to about 95 wt %, about 80 wt % to about 94 wt %, about 80 wt % to about 93 wt %, about 80 wt % to about 92 wt %, about 80 wt % to about 91 wt %, about 80 wt % to about 90 wt %, about 85 wt % to about 99.9 wt %, about 85 wt % to about 99.5 wt %, about 85 wt % to about 99 wt %, about 85 wt % to about 98 wt %, about 85 wt % to about 97 wt %, about 85 wt % to about 96 wt %, about 85 wt % to about 95 wt %, about 85 wt % to about 94 wt %, about 85 wt % to about 93 wt %, about 85 wt % to about 92 wt %, about 85 wt % to about 91 wt %, about 85 wt % to about 90 wt %, about 90 wt % to about 99.9 wt %, about 90 wt % to about 99.5 wt %, about 90 wt % to about 99 wt %, about 90 wt % to about 98 wt %, about 90 wt % to about 97 wt %, about 90 wt % to about 96 wt %, about 90 wt % to about 95 wt %, about 90 wt % to about 94 wt %, about 90 wt % to about 93 wt %, about 90 wt % to about 93 wt %, about 90 wt % to about 92 wt %, about 90 wt % to about 91 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, about 99.5 wt %, or about 99.9 wt % of the total weight of the powder composition.

In some aspects, the powder composition comprises a polymer, such as a water soluble polymer, which can be natural or synthetic. In some aspects, the polymer is a solid. Suitable examples of a polymer include, e.g., polyacrylic acid, a polyacrylate, a fluorinated polyacrylate, acrylic acid-maleic acid copolymer, polymethacrylic acid, N-(2-hydroxypropyl)methacrylamide, styrene-maleic anhydride copolymer, a polysaccharide, an alginate, a cellulose (e.g., a carboxymethyl cellulose), a starch, gelatin, or any combination thereof, including copolymers and blends thereof.

In some aspects, the powder composition comprises from about 60 wt % to about 99.9 wt % of the polymer relative to the total weight of the powder composition. For example, the polymer can be present in an amount from about 60 wt % to about 99.5 wt %, about 60 wt % to about 99 wt %, about 60 wt % to about 98 wt %, about 60 wt % to about 97 wt %, about 60 wt % to about 96 wt %, about 60 wt % to about 95 wt %, about 60 wt % to about 94 wt %, about 60 wt % to about 93 wt %, about 60 wt % to about 90 wt %, about 60 wt % to about 85 wt %, about 60 wt % to about 80 wt %, about 60 wt % to about 75 wt %, about 60 wt % to about 70 wt %, about 65 wt % to about 99.9 wt %, about 65 wt % to about 99.5 wt %, about 65 wt % to about 99 wt %, about 65 wt % to about 98 wt %, about 65 wt % to about 97 wt %, about 65 wt % to about 96 wt %, about 65 wt % to about 95 wt %, about 65 wt % to about 94 wt %, about 65 wt % to about 93 wt %, about 65 wt % to about 90 wt %, about 65 wt % to about 85 wt %, about 65 wt % to about 80 wt %, about 65 wt % to about 75 wt %, about 65 wt % to about 70 wt %, about 70 wt % to about 99.9 wt %, about 70 wt % to about 99.5 wt %, about 70 wt % to about 99 wt %, about 70 wt % to about 98 wt %, about 70 wt % to about 97 wt %, about 70 wt % to about 96 wt %, about 70 wt % to about 95 wt %, about 70 wt % to about 94 wt %, about 70 wt % to about 93 wt %, about 70 wt % to about 90 wt %, about 70 wt % to about 85 wt %, about 70 wt % to about 80 wt %, about 70 wt % to about 75 wt %, about 80 wt % to about 99.5 wt %, about 80 wt % to about 99 wt %, about 80 wt % to about 98 wt %, about 80 wt % to about 97 wt %, about 80 wt % to about 96 wt %, about 80 wt % to about 95 wt %, about 80 wt % to about 94 wt %, about 80 wt % to about 93 wt %, about 80 wt % to about 92 wt %, about 80 wt % to about 91 wt %, about 80 wt % to about 90 wt %, about 85 wt % to about 99.9 wt %, about 85 wt % to about 99.5 wt %, about 85 wt % to about 99 wt %, about 85 wt % to about 98 wt %, about 85 wt % to about 97 wt %, about 85 wt % to about 96 wt %, about 85 wt % to about 95 wt %, about 85 wt % to about 94 wt %, about 85 wt % to about 93 wt %, about 85 wt % to about 92 wt %, about 85 wt % to about 91 wt %, about 85 wt % to about 90 wt %, about 90 wt % to about 99.9 wt %, about 90 wt % to about 99.5 wt %, about 90 wt % to about 99 wt %, about 90 wt % to about 98 wt %, about 90 wt % to about 97 wt %, about 90 wt % to about 96 wt %, about 90 wt % to about 95 wt %, about 90 wt % to about 94 wt %, about 90 wt % to about 93 wt %, about 90 wt % to about 93 wt %, about 90 wt % to about 92 wt %, about 90 wt % to about 91 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, about 99.5 wt %, or about 99.9 wt % of the total weight of the powder composition.

In some aspects, the powder composition comprises at least one (e.g., 1, 2, 3, 4, 5, or 6, etc.) surfactant, particularly in aspects when the liquid composition does not comprise a surfactant. In some aspects, the surfactant is an anionic surfactant, a cationic surfactant, a zwitterionic surfactant, a nonionic surfactant, or any combination thereof, each of which is described herein. In some aspects, the surfactant in the powder composition is a solid. In some aspects, the liquid composition can comprise an anionic surfactant, such as an alkylbenzene sulfonate.

In some aspects, the powder composition comprises from about 20 wt % to about 60 wt % of a surfactant relative to the total weight of the powder composition. For example, the total surfactant content in the powder composition can be from about 20 wt % to about 58 wt %, about 20 wt % to about 55 wt %, about 20 wt % to about 52 wt %, about 20 wt % to about 50 wt %, about 20 wt % to about 48 wt %, about 20 wt % to about 45 wt %, about 20 wt % to about 42 wt %, about 20 wt % to about 40 wt %, about 20 wt % to about 35 wt %, about 20 wt % to about 30 wt %, about 20 wt % to about 25 wt %, about 25 wt % to about 60 wt %, about 25 wt % to about 58 wt %, about 25 wt % to about 55 wt %, about 25 wt % to about 52 wt %, about 25 wt % to about 50 wt %, about 25 wt % to about 48 wt %, about 25 wt % to about 45 wt %, about 25 wt % to about 42 wt %, about 25 wt % to about 40 wt %, about 25 wt % to about 35 wt %, about 25 wt % to about 30 wt %, about 28 wt % to about 60 wt %, about 28 wt % to about 58 wt %, about 28 wt % to about 55 wt %, about 28 wt % to about 52 wt %, about 28 wt % to about 50 wt %, about 28 wt % to about 48 wt %, about 28 wt % to about 45 wt %, about 28 wt % to about 42 wt %, about 28 wt % to about 40 wt %, about 28 wt % to about 35 wt %, about 28 wt % to about 30 wt %, about 30 wt % to about 60 wt %, about 30 wt % to about 58 wt %, about 30 wt % to about 55 wt %, about 30 wt % to about 52 wt %, about 30 wt % to about 50 wt %, about 30 wt % to about 48 wt %, about 30 wt % to about 45 wt %, about 30 wt % to about 42 wt %, about 30 wt % to about 40 wt %, about 30 wt % to about 35 wt %, about 32 wt % to about 60 wt %, about 32 wt % to about 58 wt %, about 32 wt % to about 55 wt %, about 32 wt % to about 52 wt %, about 32 wt % to about 50 wt %, about 32 wt % to about 48 wt %, about 32 wt % to about 45 wt %, about 32 wt % to about 42 wt %, about 32 wt % to about 40 wt %, about 32 wt % to about 35 wt %, about 35 wt % to about 60 wt %, about 35 wt % to about 58 wt %, about 35 wt % to about 55 wt %, about 35 wt % to about 52 wt %, about 35 wt % to about 50 wt %, about 35 wt % to about 48 wt %, about 35 wt % to about 45 wt %, about 35 wt % to about 42 wt %, about 35 wt % to about 40 wt %, about 38 wt % to about 60 wt %, about 38 wt % to about 58 wt %, about 38 wt % to about 55 wt %, about 38 wt % to about 52 wt %, about 38 wt % to about 50 wt %, about 38 wt % to about 48 wt %, about 38 wt % to about 45 wt %, about 38 wt % to about 42 wt %, about 38 wt % to about 40 wt %, about 40 wt % to about 60 wt %, about 40 wt % to about 58 wt %, about 40 wt % to about 55 wt %, about 40 wt % to about 52 wt %, about 40 wt % to about 50 wt %, about 40 wt % to about 48 wt %, about 40 wt % to about 45 wt %, about 40 wt % to about 42 wt %, about 42 wt % to about 60 wt %, about 42 wt % to about 58 wt %, about 42 wt % to about 55 wt %, about 42 wt % to about 52 wt %, about 42 wt % to about 50 wt %, about 42 wt % to about 48 wt %, about 42 wt % to about 45 wt %, about 45 wt % to about 60 wt %, about 45 wt % to about 58 wt %, about 45 wt % to about 55 wt %, about 45 wt % to about 52 wt %, about 45 wt % to about 50 wt %, about 45 wt % to about 48 wt %, about 48 wt % to about 60 wt %, about 48 wt % to about 58 wt %, about 48 wt % to about 55 wt %, about 48 wt % to about 52 wt %, about 48 wt % to about 50 wt %, about 50 wt % to about 60 wt %, about 50 wt % to about 58 wt %, about 50 wt % to about 55 wt %, about 50 wt % to about 52 wt %, about 52 wt % to about 65 wt %, about 52 wt % to about 60 wt %, about 52 wt % to about 58 wt %, about 52 wt % to about 55 wt %, about 55 wt % to about 60 wt %, about 55 wt % to about 58 wt %, about 58 wt % to about 65 wt %, about 58 wt % to about 60 wt %, about 60 wt %, about 59 wt %, about 58 wt %, about 57 wt %, about 56 wt %, about 55 wt %, about 54 wt %, about 53 wt %, about 52 wt %, about 51 wt %, about 50 wt %, about 49 wt %, about 48 wt %, about 47 wt %, about 46 wt %, about 45 wt %, about 44 wt %, about 43 wt %, about 42 wt %, about 41 wt %, about 40 wt %, about 39 wt %, about 38 wt %, about 37 wt %, about 36 wt %, about 35 wt %, about 34 wt %, about 33 wt %, about 32 wt %, about 31 wt %, about 30 wt %, about 29 wt %, about 28 wt %, about 27 wt %, about 26 wt %, about 25 wt %, about 24 wt %, about 23 wt %, about 22 wt %, about 21 wt %, or about 20 wt % of the total weight of the powder composition.

In an aspect, the unit dose detergent comprises a water-soluble film material comprising at least a first compartment and a second compartment; wherein the first compartment is adjacent to the second compartment and the first and second compartments are separated by at least one layer of the film;
the first compartment encloses a liquid composition comprising water, a non-aqueous solvent, an anionic surfactant, a nonionic surfactant, and at least one additive selected from a performance polymer, an anti-redeposition polymer, an enzyme, a chelating agent, and a bitterant; and
the second compartment encloses a powder composition comprising a pigment and at least one additive selected from a salt, a flow aid, acid, enzyme, and chelating agent.

In some aspects of this unit dose, the non-aqueous solvent comprises glycerin, propylene glycol, or a combination of glycerin and propylene glycol.

In an aspect, the unit dose detergent comprises
a water-soluble film material comprising at least a first compartment and a second compartment; wherein the first compartment is adjacent to the second compartment and the first and second compartments are separated by at least one layer of the film;
the first compartment encloses a liquid composition comprising water, a non-aqueous solvent, an anionic surfactant, a nonionic surfactant, and at least one additive selected from a performance polymer, an anti-redeposition polymer, an enzyme, a chelating agent, and a bitterant; and
the second compartment encloses a powder composition comprising:
   (i) a pigment and a chelating agent; or
   (ii) a pigment and a salt.

In an aspect, the unit dose detergent comprises
a water-soluble film material comprising at least a first compartment and a second compartment; wherein the first compartment is adjacent to the second compartment and the first and second compartments are separated by at least one layer of the film;
the first compartment encloses a liquid composition comprising a non-aqueous solvent, an anionic surfactant, and a nonionic surfactant; and the second compartment encloses a powder composition comprising:
   (i) a pigment and a salt;
   (ii) a pigment, a salt, and a flow aid (e.g., zeolite); or
   (iii) a pigment, a salt, a flow aid (e.g., zeolite), a surfactant (e.g., an alkylbenzene sulfonate), and an enzyme.

In an aspect, the unit dose detergent comprises
a water-soluble film material comprising at least a first compartment and a second compartment; wherein the first compartment is adjacent to the second compartment and the first and second compartments are separated by at least one layer of the film;
the first compartment encloses a liquid composition comprising a non-aqueous solvent and at least one additive selected from an enzyme and a fragrance; and the second compartment encloses a powder composition comprising:
   (i) a pigment, a salt, a flow aid (e.g., zeolite), and a surfactant (e.g., an alkylbenzene sulfonate);
   (ii) a pigment, a salt, a flow aid (e.g., zeolite), a surfactant (e.g., an alkylbenzene sulfonate), and an enzyme.

The unit dose detergent comprises at least two compartments, in which a first compartment is adjacent to a second compartment and the first and second compartments are separated by at least one layer of the film. The liquid and powder compositions are releasably disposed within the first and second compartments, respectively. In some aspects, the unit dose detergent comprises two compartments. In some aspects, the unit dose detergent can have more than 2 (e.g., 3 or 4) compartments that are sealed off from one another, and the liquid and powder compositions are releasably disposed within at least two of the compartments. In some aspects, the same powder composition is present in two compartments, while the liquid composition is disclosed in a third compartment that is adjacent to the compartments containing the powder compositions. In some aspects, different film compositions can be used to form different sections or compartments of the pouch. For example, different films can dissolve at different rates to provide timed release of the compartments' contents.

The sealing of a water-soluble film material (e.g., in the form of one or two sheets) to form a compartment can be performed using methods known to those of skill in the art. In some aspects, the water-soluble film material is sealed using heat-sealing, solvent sealing (e.g., water sealing), or ultraviolet (UV) sealing.

The first compartment is adjacent to the second compartment in any suitable configuration so long as the first and second compartments are separated by at least one layer of the water-soluble film. In an aspect, the second compartment surrounds (e.g., encircles) the first compartment. In an aspect, the first compartment surrounds (e.g., encircles) the second compartment. In another example, the first and second compartments share one side of the compartments.

The unit dose detergent (e.g., scent booster pack) can have any suitable shape and size, e.g., square, rectangular, oval, ellipsoid, superelliptical, or circular shape. In general, the size and shape of each compartment in the unit dose detergent is large enough to enclose (e.g., entrap) about 1 g to about 50 g total weight of each of the liquid and powder compositions. For example, each compartment can enclose about 1 g to about 45 g (e.g., about 1 g to about 40 g, about 1 g to about 35 g, about 1 g to about 30 g, about 1 g to about 25 g, about 1 g to about 20 g, or about 1 g to about 15 g). In some aspects, the first compartment comprising the liquid composition is smaller relative to the second compartment comprising the powder composition. In an aspect, the first compartment holds about 1 g to about 5 g of the liquid composition. In an aspect, the second compartment holds about 10 g to about 20 g of the powder composition.

The water-soluble film is desirably strong, flexible, shock resistant, and non-tacky during storage at both high and low temperatures and high and low humidities. Non-limiting examples of suitable materials for the water-soluble film include, e.g., polyvinyl alcohol (PVOH), polyvinyl acetate (PVA), film-forming cellulosic polymers, polyacrylic acid, polyacrylamide, polyanhydride, a polysaccharide, and combinations thereof. Examples of film-forming cellulosic polymer include, e.g., cellulose, cellulose ether, cellulose ester, cellulose amide, methylcellulose, carboxymethylcellulose sodium, ethylcellulose, hydroxyethyl cellulose, hydroxypropyl methyl cellulose (HPMC), and combinations thereof. Unit dose detergent packs, including water-soluble films, are described in U.S. Pat. Nos. 8,551,929, 10,774,294, and 11,492,574, the disclosures of which are incorporated herein by reference in their entirety. In some aspects, the water-soluble film material comprises polyvinyl alcohol, polyvinyl pyrrolidone, polyalkylene oxide, polyamide, polyacrylamide, polyacrylic acid, cellulose, a cellulose ether, a cellulose ester, a cellulose amide, polyvinyl acetate, polycarboxylic acid or a salt thereof, a peptide, a polysaccharide, a natural gum, or any combination thereof. In some aspects, the water-soluble film material comprises polyvinyl alcohol (PVOH) or polyvinyl acetate (PVA).

In an aspect, the water-soluble film material is polyvinyl alcohol (PVOH). In some aspects, the PVOH can have a number average molecular weight range of about 10,000 to about 100,000 g/mol (e.g., about 10,000 to about 80,000 g/mol, about 15,000 to about 60,000 g/mol, about 20,000 to about 50,000 g/mol, about 25,000 to about 40,000 g/mol, or about 27,000 to about 33,000).

In some aspects, the film material comprises a bitterant (e.g., denatonium benzoate) as described herein, to impart a bitter taste to help avoid accidental poisoning.

In some aspects, the film material can have a thickness of about 50 to about 100 μm (e.g., about 50 to about 90 μm, about 60 to about 100 μm, about 60 to about 90 μm, about 70 to about 100 μm, about 70 to about 90 μm, about 80 to about 100 μm, about 80 to about 90 μm, about 100 μm, about 99 μm, about 98 μm, about 97 μm, about 96 μm, about 95 μm, about 94 μm, about 93 μm, about 92 μm, about 91 μm, about 90 μm, about 89 μm, about 88 μm, about 87 μm, about 86 μm, about 85 μm, about 84 μm, about 83 μm, about 82 μm, about 81 μm, about 80 μm, about 79 μm, about 79 μm, about 78 μm, about 77 μm, about 76 μm, about 75 μm, about 74 μm, about 73 μm, about 72 μm, about 71 μm, about 70 μm, about 69 μm, about 68 μm, about 67 μm, about 66 μm, about 65 μm, about 64 μm, about 63 μm, about 62 μm, about 61 μm, about 60 μm, about 59 μm, about 58 μm, about 57 μm, about 56 μm, about 55 μm, about 54 μm, about 53 μm, about 52 μm, about 51 μm, or about 50 μm). In some aspects, the film material will have a thickness of about 80 to about 90 μm or about 88 μm.

In some aspects, the present disclosure is directed to a method of using the unit dose product of any of the foregoing aspects. For example, the unit dose product can be used in a method of removing soil from a textile (e.g., cleaning a textile, such as a fabric). In particular, the present disclosure is directed to a method of removing soil from a textile comprising contacting the textile with a composition comprising the unit dose product described herein and water to form a washing load. Optional steps include mixing (agitating) the washing load and composition, removing the composition to provide a clean textile, rinsing the clean textile with additional water, and isolating the clean textile. In some aspects, soils that are suitably removed using the unit dose product include, but are not limited to, oil-containing soils, carbohydrate-containing soils, protein-containing soils, tannin-containing soils, particulate soils, and combinations thereof.

In some aspects of these methods, the method can be performed using a washing machine, a tergotometer, or an equivalent device. In some aspects of these methods, the water is hot or warm water (e.g., about 21-35° C., about 22-32° C., about 25-35° C., about 25-32° C., about 28-35° C., about 30-35° C., or about 32° C.). In some aspects of these methods, the water is cold water (e.g., about 10-20° C., about 12-16° C., or about 15° C.).

It was discovered that the order of addition in manufacturing the powder composition influenced the powder color and ability to stain. As a result, the powder can be produced using different orders to provide different benefits.

It was discovered that the following order of addition maximizes brightness and color intensity of the powder: 1) salt base, 2) flow aid, and 3) pigment. While not wishing to be bound by theory, it is believed that the brightened appearance was due to the pigment coating the outside of each granule and not being covered by the flow aid. This is also believed to be why powder made using this order of addition is more prone to staining fabrics. When the powder contacts the fabric, the pigment is unhindered in depositing onto the fabric. To mitigate stain risk, it was discovered that pigments incorporated using this order of addition should be included at levels as low as about 0.001 wt % to about 0.5 wt %.

It was discovered that the following alternative order of addition minimizes risk of staining fabrics: 1) salt base, 2) pigment, and 3) flow aid. While not wishing to be bound by theory, it is believed that when powder is produced using this order of addition, pigment first coats the granules of the salt base. Then flow aid coats the pigmented granules. The flow aid coating hinders staining but also dulls color. To maintain aesthetic acceptability, in some aspects, some pigments can be included at levels as high as about 1 wt % to about 3 wt % to overcome this color dulling.

Accordingly, the present disclosure is directed to a method of preparing the powder composition enclosed in the second compartment of a unit dose detergent described herein. The method comprises adding the pigment to a salt to provide a pigment-salt combination; followed by adding a flow aid to the pigment-salt combination to form the powder composition. In another aspect, the present disclosure is directed to a method of preventing pigment stains on a textile comprising providing the unit dose detergent, in which the powder composition is prepared by adding the pigment to a salt to provide a pigment-salt combination; followed by adding a flow aid to the pigment-salt combination to form the powder composition. In some aspects of the method, the powder composition comprises about 0.001 wt % to about 3 wt % (e.g., about 0.05 wt % to about 3 wt %, about 0.5 wt % to about 3 wt %, about 1 wt % to about 3 wt %) of pigment. In some aspects of the method, the salt comprises a chloride, a bromide, an iodide, a fluoride, a nitrate, a nitrite, a sulfate, a sulfite, a sulfide, a phosphate, a phosphide, a carbonate, a bicarbonate, a citrate, or any combination thereof. In some aspects of the method, the flow aid comprises silica, calcium oxide, a silicate, an aluminate, a citrate, a carbonate, a bicarbonate, a phosphate, a stearate, a clay, flour, fly ash, starch, zeolite, or any combination thereof.

In some aspects, the method further comprises rinsing the textile with water and drying the textile. Once the textile has been dried, the presence or absence of a pigment stain can be visually measured. When a stain has been prevented, the visual measurement can be labeled as “clean” or “small amount of acceptable staining.” In some aspects, the textile is cotton, silk, wool, polyester, rayon, leather, linen, muslin, velvet, chenille, brocade, chiffon, denim, taffeta, organza, crepe, poplin, broadcloth, or any combination thereof. In some aspects, the textile is cotton.

### EXAMPLES

These examples are provided for the purpose of illustration only and the embodiments described herein should in no way be construed as being limited to these examples. Rather, the embodiments should be construed to encompass any and all variations which become evident as a result of the teaching provided herein.

### Example 1

Unit dose detergents comprising liquid and powder compositions can be prepared in accordance with the components listed in Tables 1-8.

TABLE 1

| | wt % | wt % | wt % |
|---|---|---|---|
| Raw Material | liquid | powder | pac |
| Liquid component | | | 85% |
| C12-15 alcohols ethoxylated (AE) | 20.5% | | 17.43% |
| Glycerin | 8.78% | | 7.46% |
| Propylene Glycol | 9.14% | | 7.77% |
| MEA-cocoate | 5.76% | | 4.89% |
| Disodium distyrylbiphenyl | 0.3% | | 0.26% |
| disulfonate | | | |
| MEA-LAS | 18.44% | | 15.67% |
| Sodium cocoate | 10% | | 8.50% |
| Sodium laureth sulfate | 14.17% | | 12.04% |
| Polyethyleneimine alkoxylated | 1.88% | | 1.59% |
| bitterant | 0.04% | | 0.03% |
| Hydrophobically modified | 1.5% | | 1.28% |
| copolymer | | | |
| Tetrasodium iminodisuccinate | 0.9% | | 0.77% |
| Enzymes | 2.3% | | 1.96% |
| Acrylates copolymer | 1% | | 0.85% |
| Water, demineralized | 5.3% | | 4.5% |
| Powder component | | | 14% |
| Anhydrous citric acid | | 99.85% | 13.98% |
| Ultramarine blue pigment | | 0.15% | 0.02% |
| Water-soluble film | | | 1% |

TABLE 2

| | wt % | wt % | wt % |
|---|---|---|---|
| Raw Material | liquid | powder | pac |
| Liquid component | | | 85% |
| C12-15 alcohols ethoxylated (AE) | 20.5% | | 17.43% |
| Glycerin | 8.78% | | 7.46% |
| Propylene Glycol | 9.14% | | 7.77% |
| MEA-cocoate | 5.76% | | 4.89% |
| Disodium distyrylbiphenyl | 0.3% | | 0.26% |
| disulfonate | | | |
| MEA-LAS | 18.44% | | 15.67% |
| Sodium cocoate | 10% | | 8.5% |
| Sodium laureth sulfate | 14.17% | | 12.04% |
| Polyethyleneimine alkoxylated | 1.88% | | 1.59% |
| bitterant | 0.04% | | 0.03% |
| Hydrophobically modified | 1.5% | | 1.28% |
| copolymer | | | |
| Enzymes | 2.3% | | 1.96% |
| Acrylates copolymer | 1% | | 0.85% |
| Water, demineralized | 6.2% | | 5.27% |
| Powder component | | | 14% |
| Pentasodium pentetate | | 99.85% | 13.98% |
| Ultramarine blue pigment | | 0.15% | 0.02% |
| Water-soluble film | | | 1% |
| Sodium cocoate | 10% | | 8.5% |

TABLE 3

| | wt % | wt % | wt % |
|---|---|---|---|
| Raw Material | liquid | powder | pac |
| Liquid component | | | 85% |
| C12-15 alcohols ethoxylated (AE) | 20.5% | | 17.43% |
| Glycerin | 8.78% | | 7.46% |
| Propylene Glycol | 9.14% | | 7.77% |
| MEA-cocoate | 5.76% | | 4.89% |
| Disodium distyrylbiphenyl | 0.3% | | 0.26% |
| disulfonate | | | |
| MEA-LAS | 18.44% | | 15.67% |
| Sodium cocoate | 10% | | 8.5% |
| Sodium laureth sulfate | 14.17% | | 12.04% |
| Polyethyleneimine alkoxylated | 1.88% | | 1.59% |
| Bitterant | 0.04% | | 0.03% |
| Hydrophobically modified | 1.5% | | 1.28% |
| copolymer | | | |
| Enzymes | 2.3% | | 1.96% |
| Acrylates copolymer | 1% | | 0.85% |
| Water, demineralized | 6.2% | | 5.27% |
| Powder component | | | 14% |
| Sodium carbonate | | 99.85% | 13.98% |
| Ultramarine blue pigment | | 0.15% | 0.02% |
| Water-soluble film | | | 1% |

TABLE 4

| | wt % | wt % | wt % |
|---|---|---|---|
| Raw Material | liquid | powder | pac |
| Liquid component | | | 85% |
| C12-15 alcohols ethoxylated (AE) | 25% | | 21.25% |
| Glycerin | 9% | | 7.65% |
| Propylene Glycol | 9% | | 7.65% |
| MEA-cocoate | 6% | | 5.1% |
| MEA-LAS | 21% | | 17.85% |
| Sodium cocoate | 10% | | 8.5% |
| Sodium laureth sulfate | 20% | | 17% |
| Powder component | | | 14% |
| Sodium chloride | | 99.85% | 13.98% |
| Ultramarine blue pigment | | 0.15% | 0.02% |
| Water-soluble film | | | 1% |

TABLE 5

| | wt % | wt % | wt % |
|---|---|---|---|
| Raw Material | liquid | powder | pac |
| Liquid component | | | 85% |
| C12-15 alcohols ethoxylated (AE) | 25% | | 21.25% |
| Glycerin | 9% | | 7.65% |
| Propylene Glycol | 9% | | 7.65% |
| MEA-cocoate | 6% | | 5.1% |
| MEA-LAS | 21% | | 17.85% |
| Sodium cocoate | 10% | | 8.50% |
| Sodium lareth sulfate | 20% | | 17% |
| Powder component | | | 14% |
| Sodium chloride | | 98.85% | 13.84% |
| Zeolite | | 1% | 0.14% |
| Ultramarine blue pigment | | 0.15% | 0.02% |
| Water-soluble film | | | 1% |

TABLE 6

| | wt % | wt % | wt % |
|---|---|---|---|
| Raw Material | liquid | powder | pac |
| Liquid component | | | 19% |
| C12-15 alcohols ethoxylated (AE) | 25% | | 4.75% |
| Glycerin | 9% | | 1.71% |
| Propylene Glycol | 9% | | 1.71% |
| MEA-cocoate | 6% | | 1.14% |
| MEA-LAS | 21% | | 3.99% |
| Sodium cocoate | 10% | | 1.9% |
| Sodium lareth sulfate | 20% | | 3.8% |
| Powder component | | | 80% |
| Sodium carbonate | | 35.35% | 28.28% |
| Sodium sulfate | | 30% | 24% |
| Sodium alkylbenzene sulfonate | | 30% | 24% |
| Enzymes | | 2.5% | 2% |
| Zeolite | | 2% | 1.6% |
| Ultramarine blue pigment | | 0.15% | 0.12% |
| Water-soluble film | | | 1% |

TABLE 7

| | wt % | wt % | wt % |
|---|---|---|---|
| Raw Material | liquid | powder | pac |
| Liquid component | | | 8% |
| Fragrance | 25% | | 2% |
| Glycerin | 75% | | 6% |
| Powder component | | | 91% |
| Sodium carbonate | | 35.35% | 32.17% |
| Sodium sulfate | | 30% | 27.3% |
| Sodium alkylbenzene sulfonate | | 30% | 27.3% |
| Enzymes | | 2.5% | 2.28% |
| Zeolite | | 2% | 1.82% |
| Ultramarine blue pigment | | 0.15% | 0.14% |
| Water-soluble film | | | 1% |

TABLE 8

| | wt % | wt % | wt % |
|---|---|---|---|
| Raw Material | liquid | powder | pac |
| Liquid component | | | 8% |
| Fragrance | 25% | | 2% |
| Enzymes | 5% | | 0.4% |
| Propylene Glycol | 70% | | 5.6% |
| Powder component | | | 91% |
| Sodium carbonate | | 37.85% | 2.12% |
| Sodium sulfate | | 30% | 1.68% |
| Sodium alkylbenzene sulfonate | | 30% | 1.68% |
| Zeolite | | 2% | 0.11% |
| Ultramarine blue pigment | | 0.15% | 0.01% |
| Water-soluble film | | | 1% |

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A unit dose detergent comprising a water-soluble film material comprising at least a first compartment and a second compartment; wherein the first compartment is adjacent to the second compartment and the first and second compartments are separated by at least one layer of the film;
the first compartment enclosing a liquid composition comprising a non-aqueous solvent; and
the second compartment enclosing a powder composition comprising a pigment and at least one additive selected from a salt, a flow aid, acid, enzyme, chelating agent, a polymer, and any combination thereof;
wherein at least one of the liquid composition and the powder composition comprises a surfactant.

2. The unit dose detergent of claim 1, wherein the pigment comprises at least one metal selected from the group consisting of aluminum, barium, cadmium, chromium, cobalt, copper, iron oxide, manganese, mercury, titanium, zinc, and any combination thereof.

3. The unit dose detergent of claim 1, wherein the powder composition comprises about 0.001 wt % to about 3 wt % of pigment.

4. The unit dose detergent of claim 1, wherein the powder composition does not contain a dye.

5. The unit dose detergent of claim 1, wherein the non-aqueous solvent comprises an alcohol, a polyol, or a combination thereof.

6. The unit dose detergent of claim 5, wherein the non-aqueous solvent comprises glycerin, propylene glycol, or a mixture thereof.

7. The unit dose detergent of claim 1, wherein the liquid composition further comprises an additive selected from water, enzyme, performance polymer, rheology modifier, anti-redeposition polymer, chelating agent, fragrance, bitterant, and any combination thereof.

8. The unit dose detergent of claim 7, wherein the liquid composition comprises water in an amount of 1 wt % to 20 wt % relative to the components in the liquid composition.

9. The unit dose detergent of claim 8, wherein the liquid composition comprises about 3 wt % to about 8 wt % water.

10. The unit dose detergent of claim 1, wherein the liquid composition comprises at least one surfactant selected from a cocamide monethanolamine (MEA-cocoate), a cocoate, a monoethanolamine salt of a linear alkylbenzene sulfonate (MEA-LAS), an alkylether sulfate, a distyrylbiphenyl disulfonate, and any combination thereof.

11. The unit dose detergent of claim 1, wherein the liquid composition has a pH of about 7.5 to about 11.

12. The unit dose detergent of claim 1, wherein the powder composition comprises a salt selected from a chloride, a bromide, an iodide, a fluoride, a nitrate, a nitrite, a sulfate, a sulfite, a sulfide, a phosphate, a phosphide, a carbonate, a bicarbonate, and any combination thereof.

13. The unit dose detergent of claim 1, wherein the powder composition comprises a flow aid selected from zeolite, calcium oxide, silica, a silicate, an aluminate, a citrate, a carbonate, a bicarbonate, a phosphate, a stearate, a clay, flour, fly ash, starch, and any combination thereof.

14. The unit dose detergent of claim 1, wherein the powder composition comprises an alkylbenzene sulfonate.

15. The unit dose detergent of claim 1, wherein the second compartment surrounds the first compartment.

16. The unit dose detergent of claim 1, wherein the water-soluble film material comprises polyvinyl alcohol.

17. A method of preparing the powder composition of the unit dose detergent of claim 1 comprising adding the pigment to a salt to provide a pigment-salt combination;
followed by adding a flow aid to the pigment-salt combination to form the powder composition.

18. The method of claim 17, wherein the powder composition comprises about 0.001 wt % to about 3 wt % of pigment.

19. The method of claim 17, wherein the salt comprises a chloride, a bromide, an iodide, a fluoride, a nitrate, a nitrite, a sulfate, a sulfite, a sulfide, a phosphate, a phosphide, a carbonate, a bicarbonate, a citrate, or any combination thereof.

20. The method of claim 17, wherein the flow aid comprises silica, calcium oxide, a silicate, an aluminate, a citrate, a carbonate, a bicarbonate, a phosphate, a stearate, a clay, flour, fly ash, starch, zeolite, or any combination thereof.
